(19) United States
(12) Patent Application Publication
(10) Pub. No.: US 2026/0077299 A1
(43) Pub. Date: Mar. 19, 2026

(54) GAS SEPARATION MEMBRANES, METHODS OF PREPARING MEMBRANES, AND METHODS OF SEPARATING GASES

(71) Applicant: Zenith Purification, LLC, Missouri City, TX (US)

(72) Inventor: Jian J. ZOU, Sugar Land, TX (US)

(21) Appl. No.: 19/110,028

(22) PCT Filed: Sep. 8, 2023
(86) PCT No.: PCT/US2023/032237

§ 371 Date: Mar. 7, 2025

Related U.S. Application Data
(60) Provisional application No. 63/404,877, filed on Sep. 8, 2022.
(60) Provisional application No. 63/404,887, filed on Sep. 8, 2022.

(51) Int. Cl. B01D 53/22; B01D 69/02; B01D 69/08; B01D 69/10; B01D 69/12; B01D 71/38; B01D 71/40; B01D 71/60; B01D 71/76

(52) U.S. Cl. CPC B01D 53/228; B01D 69/02; B01D 69/08; B01D 69/1071; B01D 69/12; B01D 71/381; B01D 71/40; B01D 71/60; B01D 71/601; B01D 71/76; B01D 2257/11; B01D 2257/302; B01D 2257/304; B01D 2257/404; B01D 2257/504; B01D 2258/0283; B01D 2258/05; B01D 2325/04; B01D 2325/34

(57) ABSTRACT

Embodiments of the present disclosure generally relate to gas separation membranes which have one or more selective layers, methods for preparing such membranes, and methods for separating gases with such membranes. The gas separation membranes are capable of permeating one gas component selectively to a low-pressure or low-concentration permeate side at a greater transport rate than other gas components. In one or more embodiments, a separation membrane is provided and includes a non-woven fabric backing, a porous support layer disposed on the non-woven fabric backing, a gutter layer disposed on the porous support layer, and one or more selective layers disposed on or above the gutter layer. Each of the selective layers independently contains a selective polymeric material, and at least one of the selective layers contains an ethylene vinyl alcohol polymeric material as the selective polymeric material.

### CROSS-REFERENCE TO RELATED APPLICATIONS

This application claims benefit to U.S. Prov. Appl. No. 63/404,877, filed on Sep. 8, 2022, and U.S. Prov. Appl. No. 63/404,887, filed on Sep. 8, 2022, which are herein incorporated by reference in their entirety.

### BACKGROUND

### Field

Embodiments of the present disclosure generally relate to membrane technology, and more specifically, gas separation membranes, methods for preparing such membranes, and methods for separating gases with such membranes.

### Description of the Related Art

Separating or removing one or more gas components from a gas mixture is an important process within the chemical, petrochemical, and energy industries. For example, separating carbon dioxide from gas mixtures such as air and flue gas to reduce the impacts of global warming has been widely researched. Another example is the removing of carbon dioxide and hydrogen sulfide from the raw natural gas to meet the natural gas pipeline specification. Another example is the separating of helium from the raw natural gas mixture to produce pure helium.

Industrial gas separation technologies can be divided into three main categories: (1) separation with sorbents/solvents; (2) cryogenic distillation process; and (3) separation with membranes. In the separation with sorbents/solvents technologies, the targeted gas component is first adsorbed on a surface of a material, such as zeolite and activated carbon, or absorbed into a bulk material, such as a solvent, then the sorbent/solvent loaded with the targeted gas is depressurized or heated to release the targeted gas. In the cryogenic distillation process, a gas mixture with different components is liquified by a series of compression, cooling and expansion steps, then the liquid is distilled at the boiling points of the different components to achieve separation. In the membrane separation, the gas mixture enters a membrane unit on the high-pressure or high-concentration feed side. Due to the selectivity of the membrane, one gas component selectively permeates through the membrane to the low-pressure or low-concentration permeate side at a greater transport rate than other gas components. As the result, the component that transports more rapidly is enriched on the low-pressure or low-concentration permeate side, while the components that transport more slowly become concentrated on the feed side. There remains a need in the art for additional membrane compositions, methods of making membranes, and methods of separating gases using membranes.

A first class of membranes, such as microporous membranes, is used for ultrafiltration, microfiltration, and microporous Knudsen diffusion gas separation. The microporous membranes contain pores greater than 10 Å in diameter and transport occurs by pore flow through these larger pores. On the other hand, a second class of membranes, such as non-porous membranes, is used for reverse osmosis, pervaporation, and polymeric gas separation. The non-porous membranes contain a dense selective polymer layer with no visible pores. The spaces disposed between polymer chains in the non-porous membranes are 10 Å or less in diameter and transport occurs by diffusing through these smaller spaces. These spaces are within the normal range of thermal motion of the polymer chains that make up the polymer matrix.

The current commercial gas separation membranes, such as membranes based on cellulose acetate and polyimides, have some limitations. For example, these gas separation membranes are susceptible to degradation caused by heavier hydrocarbons present in raw natural gas and are not suitable for removing particular gas components in low concentrations (e.g., such as ppm concentrations of carbon dioxide in air).

Therefore, there is a need for improved gas separation membranes and methods for preparing such membranes, and methods for separating gases with such membranes.

### SUMMARY

Embodiments of the present disclosure generally relate to gas separation membranes which have one or more selective layers, methods for preparing such membranes, and methods for separating gases with such membranes. The gas separation membranes are capable of permeating one gas component selectively to a low-pressure or low-concentration permeate side at a greater transport rate than other gas components.

In one or more embodiments, a separation membrane is provided and includes a non-woven fabric backing, a porous support layer disposed on the non-woven fabric backing, a gutter layer disposed on the porous support layer, and one or more selective layers disposed on or above the gutter layer. Each of the selective layers independently contains a selective polymeric material, and at least one of the selective layers contains an ethylene vinyl alcohol polymeric material as the selective polymeric material.

In some embodiments, a separation membrane is provided and includes a non-woven fabric backing, a porous support layer disposed on the non-woven fabric backing, and one or more selective layers disposed on or above the porous support layer. Each of the selective layers independently contains a selective polymeric material, and at least one of the selective layers contains an ethylene vinyl alcohol polymeric material as the selective polymeric material.

In other embodiments, a separation membrane is provided and includes a non-woven fabric backing, a porous support layer disposed on the non-woven fabric backing, a gutter layer disposed on the porous support layer, a first selective layer disposed on the gutter layer and containing a first selective polymeric material, and a second selective layer disposed on the first selective layer. The second selective layer contains a second selective polymeric material. The first selective polymeric material, the second selective polymeric material, or both the first and second selective polymeric materials contains an ethylene vinyl alcohol polymeric material.

In some embodiments, a separation membrane is provided and includes a non-woven fabric backing, a porous support layer disposed on the non-woven fabric backing, a first selective layer disposed on the porous support layer and containing a first selective polymeric material, and a second selective layer disposed on the first selective layer and containing a second selective polymeric material. The first selective polymeric material, the second selective polymeric material, or both the first and second selective polymeric materials contains an ethylene vinyl alcohol polymeric material.

In one or more embodiments, a separation membrane is provided and includes a porous support layer, a gutter layer disposed on the porous support layer, and one or more selective layers disposed on or above the gutter layer. Each of the selective layers independently contains a selective polymeric material, and at least one of the selective layers contains an ethylene vinyl alcohol polymeric material as the selective polymeric material.

In some embodiments, a separation membrane is provided and includes a porous support layer and one or more selective layers disposed on or above the porous support layer. Each of the selective layers independently contains a selective polymeric material, and at least one of the selective layers contains an ethylene vinyl alcohol polymeric material as the selective polymeric material.

In other embodiments, a separation membrane is provided and includes a porous support layer, a gutter layer disposed on the porous support layer, a first selective layer disposed on the gutter layer and containing a first selective polymeric material, and a second selective layer disposed on the first selective layer and containing a second selective polymeric material. The first selective polymeric material, the second selective polymeric material, or both the first and second selective polymeric materials contains an ethylene vinyl alcohol polymeric material.

In some embodiments, a separation membrane is provided and includes a porous support layer, a first selective layer disposed on the porous support layer and containing a first selective polymeric material, and a second selective layer disposed on the first selective layer and containing a second selective polymeric material. The first selective polymeric material, the second selective polymeric material, or both the first and second selective polymeric materials contains an ethylene vinyl alcohol polymeric material.

In one or more embodiments, a method for separating a targeted gas is provided and includes introducing a gas mixture containing the targeted gas and a base gas to a feed side of one or more separation membrane described and discussed herein. The separation membrane contains the feed side opposite of a permeate side. The method further includes removing the targeted gas from the feed side of the separation membrane while retaining the base gas on the feed side, and recovering the targeted gas from the permeate side. The gas mixture can be or contain air, natural gas, flue gas, syngas, biogas, one or more gases from refineries, power plants, cement plants, and/or steel plants, or any combination thereof. In some embodiments, the targeted gas contains helium, hydrogen (H₂), oxygen (O₂), or any combination thereof and the base gas contains methane, ethane, ethene, propylene, other hydrocarbon gases, nitrogen (N₂), carbon dioxide, carbon monoxide, hydrogen sulfide, ammonia, water, or any combination thereof. In other embodiments, the targeted gas contains carbon dioxide, hydrogen sulfide, hydrogen chloride, hydrogen fluoride, nitrogen oxide, sulfur oxide, or any combination thereof and the base gas contains methane, a hydrocarbon gas, nitrogen (N₂), oxygen (O₂), hydrogen (H₂), argon, helium, carbon monoxide, or any combination thereof.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 depicts a cross-sectional view of a flat sheet membrane, as described and discussed in one or more embodiments herein.

FIG. 2 depicts a cross-sectional view of another flat sheet membrane, as described and discussed in one or more embodiments herein.

FIG. 3 depicts a cross-sectional view of another flat sheet membrane, as described and discussed in one or more embodiments herein.

FIG. 4 depicts a cross-sectional view of another flat sheet membrane, as described and discussed in one or more embodiments herein.

FIG. 5 depicts a cross-sectional view of a hollow fiber membrane, as described and discussed in one or more embodiments herein.

FIG. 6 depicts a cross-sectional view of another hollow fiber membrane, as described and discussed in one or more embodiments herein.

FIG. 7 depicts a cross-sectional view of another hollow fiber membrane, as described and discussed in one or more embodiments herein.

FIG. 8 depicts a cross-sectional view of another hollow fiber membrane, as described and discussed in one or more embodiments herein.

To facilitate understanding, identical reference numerals have been used, where possible, to designate identical elements that are common to the Figures. It is contemplated that elements and features of one or more embodiments may be beneficially incorporated in other embodiments.

### DETAILED DESCRIPTION

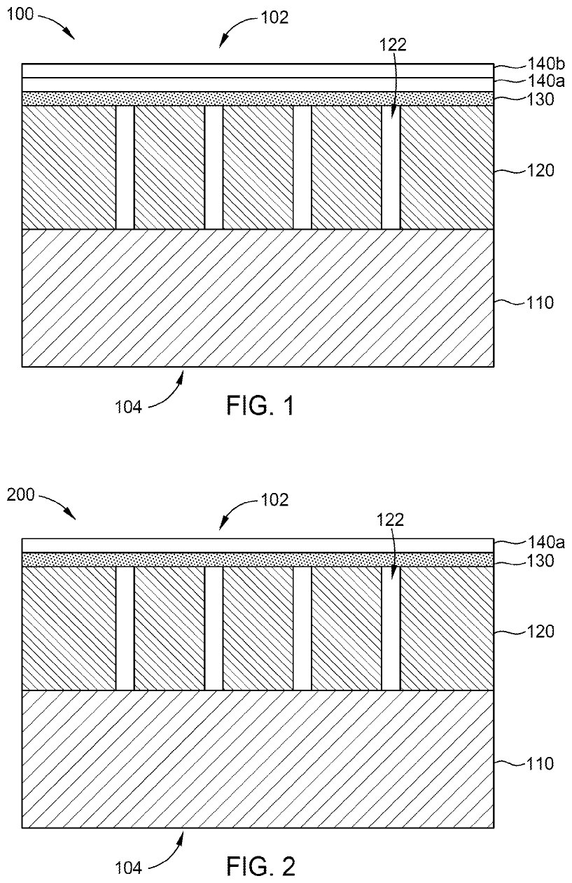

Embodiments of the present disclosure generally relate to gas separation membranes which have one or more selective layers, methods for preparing such membranes, and methods for separating gases with such membranes. The gas separation membranes are capable of permeating one gas component selectively to a low-pressure or low-concentration permeate side at a greater transport rate than other gas components. FIGS. 1-8 depict cross-sectional views of separation membranes 100-800, respectively, as described and discussed in various embodiments herein. The separation membranes 100-800 are exemplary membranes and other variations of these membranes are in the scope on the present disclosure.

Each of the separation membranes 100-800 has a feed side 102 opposite of a permeate side 104. During gas separation, a gas mixture containing a targeted gas and a base gas is introduced to the feed side 102. The targeted gas is removed from the feed side 102 by passing through the separation membranes 100-800, and recovered at the permeate side 104. The remaining base gas is retained, or substantially retained at the feed side 102. The base gas, before separation, includes the targeted gas and the remaining base gas.

In embodiments described and discussed herein, each of the separation membranes 100-800 contain one, two, or more selective layers 140 which are used to selectively permeate one gas component over another gas component. The selective layers, as described and discussed herein, are non-porous membranes which contain a dense selective polymeric layer without pores of greater than 10 Å. The spaces disposed between polymer chains in the non-porous membranes are 10 Å or less (e.g., about 1 Å to about 10 Å) in diameter and selective gas transport occurs by diffusion through these spaces.

FIG. 1 depicts a cross-sectional view of a separation membrane 100, such as a flat sheet membrane, as described and discussed in one or more embodiments herein. The separation membrane 100 contains a non-woven fabric backing 110, a porous support layer 120 containing a plurality of pores 122 and disposed on or above the non-woven fabric backing 110, a gutter layer 130 disposed on or above the porous support layer 120, and one, two, or more selective layers 140a, 140b (collectively selective layers 140) disposed on or above the gutter layer 130. As shown in FIG. 1, the separation membrane 100 contains the selective layer 140a disposed directly on the gutter layer 130 and the selective layer 140b disposed directly on the selective layer 140a.

In one or more examples, each of the selective layers 140a, 140b independently contains one or more selective polymeric materials, and at least one of the selective layers 140a, 140b contains one or more ethylene vinyl alcohol polymeric materials, one or more poly(vinyl alcohol) polymeric materials, one or more amine-containing polymeric materials, or any combination thereof as the selective polymeric material. In some examples, the first selective layer 140a is directly disposed on the gutter layer 130 and contains a first selective polymeric material and a second selective layer 140b is directly disposed on the first selective layer 140a. The second selective layer 140b contains a second selective polymeric material. In one or more examples, the first selective polymeric material, the second selective polymeric material, or both the first and second selective polymeric materials independently contains one or more ethylene vinyl alcohol polymeric materials.

FIG. 2 depicts a cross-sectional view of a separation membrane 200, such as another flat sheet membrane, as described and discussed in one or more embodiments herein. The separation membrane 200 contains the non-woven fabric backing 110, the porous support layer 120 containing the plurality of pores 122 and disposed on or above the non-woven fabric backing 110, the gutter layer 130 disposed on or above the porous support layer 120, and the selective layer 140a disposed on or above the gutter layer 130. In some embodiments, the separation membrane 200 contains similar layers as the separation membrane 100, but lacks the second selective layer 140b, so has a single selective layer 140a.

In other embodiments, not shown in the Figures, the separation membranes 100, 200 (as well as separation membranes 300-800) can include any number of selective layers 140. For example, any of the separation membranes 100-800 can include a range from 1, 2, 3, 4, or 5 selective layers 140 to about 6, 7, 8, 9, 10, 12, 15, 20, 35, 50, 80, 100, 150, 200, or more selective layers 140. In one or more embodiments, a plurality of selective layers 140 is disposed on or over the gutter layer 130 or the porous support layer 120, and the plurality of selective layers 140 contains from 3 selective layers 140 to about 200 selective layers 140. In some embodiments, each of the selective layers 140 contains a different composition than the composition of an adjacent or neighboring selective layer 140.

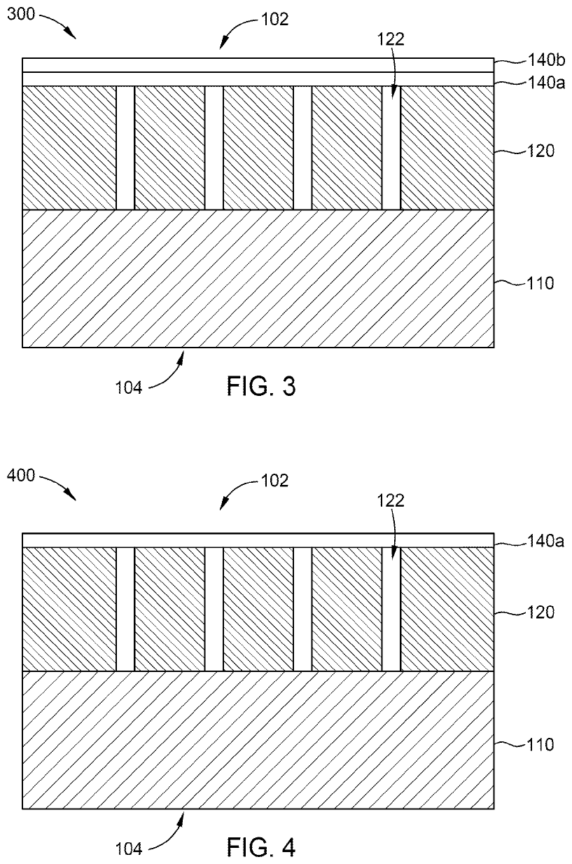

FIG. 3 depicts a cross-sectional view of a separation membrane 300, such as another flat sheet membrane, as described and discussed in one or more embodiments herein. The separation membrane 300 contains the non-woven fabric backing 110, the porous support layer 120 disposed on or above the non-woven fabric backing 110, and one, two, or more selective layers 140 (two selective layers 140a, 140b are shown) disposed on or above the porous support layer 120. In one or more examples, each of the selective layers 140a, 140b independently contains one or more selective polymeric materials. In some examples, at least one of the selective layers 140a, 140b contains one or more ethylene vinyl alcohol polymeric materials. In some embodiments, the separation membrane 300 contains similar layers as the separation membrane 100, but lacks the gutter layer 130. As shown in FIG. 3, the separation membrane 300 contains the selective layer 140a disposed directly on the porous support layer 120 and the selective layer 140b disposed directly on the selective layer 140a.

FIG. 4 depicts a cross-sectional view of a separation membrane 400, such as another flat sheet membrane, as described and discussed in one or more embodiments herein. The separation membrane 400 contains the non-woven fabric backing 110, the porous support layer 120 disposed on or above the non-woven fabric backing 110, the selective layer 140a disposed on or above the porous support layer 120. As shown in FIG. 4, the separation membrane 400 contains the selective layer 140a disposed directly on the porous support layer 120.

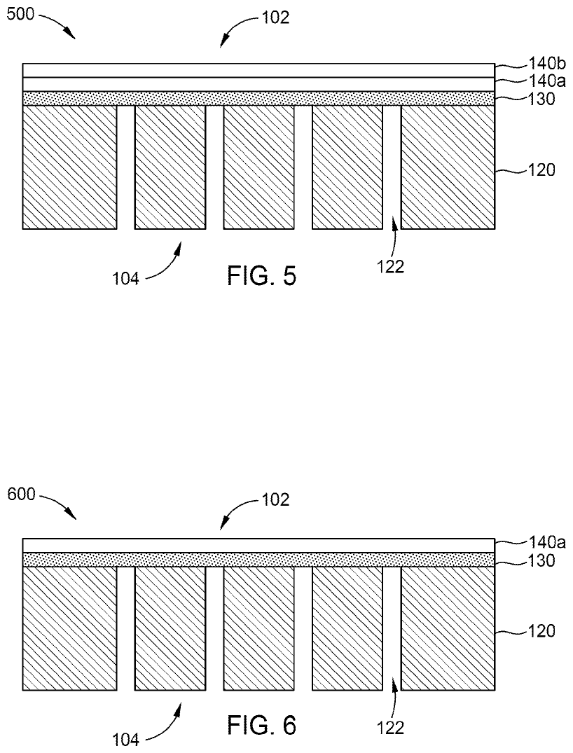

FIG. 5 depicts a cross-sectional view of a separation membrane 100, such as a hollow fiber membrane, as described and discussed in one or more embodiments herein. The separation membrane 500 contains the porous support layer 120 containing the plurality of pores 122, the gutter layer 130 disposed on or above the porous support layer 120, and one, two, or more selective layers 140a, 140b (collectively selective layers 140) disposed on or above the gutter layer 130. As shown in FIG. 5, the separation membrane 500 contains the selective layer 140a disposed directly on the gutter layer 130 and the selective layer 140b disposed directly on the selective layer 140a. In some embodiments, the separation membrane 500 contains similar layers as the separation membrane 100, but lacks the non-woven fabric backing 110.

FIG. 6 depicts a cross-sectional view of a separation membrane 600, such as another hollow fiber membrane, as described and discussed in one or more embodiments herein. The separation membrane 600 contains the porous support layer 120 containing the plurality of pores 122, the gutter layer 130 disposed on or above the porous support layer 120, and the selective layer 140a disposed on or above the gutter layer 130. In some embodiments, the separation membrane 600 contains similar layers as the separation membrane 200, but lacks the non-woven fabric backing 110.

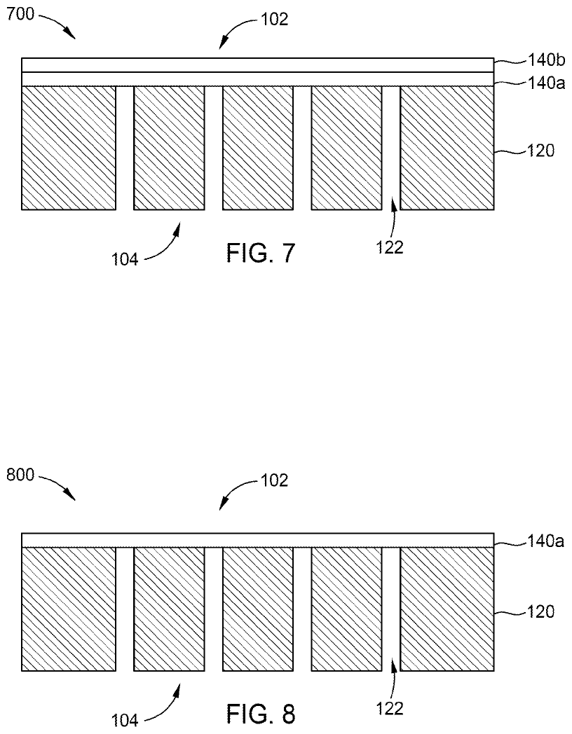

FIG. 7 depicts a cross-sectional view of a separation membrane 700, such as another hollow fiber membrane, as described and discussed in one or more embodiments herein. The separation membrane 700 contains the porous support layer 120, and one, two, or more selective layers 140 (two selective layers 140a, 140b are shown) disposed on or above the porous support layer 120. In one or more examples, each of the selective layers 140a, 140b independently contains one or more selective polymeric materials. In some examples, at least one of the selective layers 140a, 140b contains one or more ethylene vinyl alcohol polymeric materials. In some embodiments, the separation membrane 700 contains similar layers as the separation membrane 300, but lacks the non-woven fabric backing 110. As shown in FIG. 7, the separation membrane 700 contains the selective layer 140a disposed directly on the porous support layer 120 and the selective layer 140b disposed directly on the selective layer 140a.

FIG. 8 depicts a cross-sectional view of a separation membrane 800, such as another hollow fiber membrane, as described and discussed in one or more embodiments herein. The separation membrane 800 contains the selective layer 140a disposed on or above the porous support layer 120. As shown in FIG. 8, the separation membrane 800 contains the selective layer 140a disposed directly on the porous support layer 120. In some embodiments, the separation membrane 800 contains similar layers as the separation membrane 400, but lacks the non-woven fabric backing 110.

In one or more embodiments, any of the separation membranes 100-800 can have a thickness in a range from about 60 μm, about 80 μm, about 100 μm, about 150 μm, about 200 μm, about 250 μm, about 300 μm, about 350 μm, about 400 μm, or about 500 μm to about 550 μm, about 600 μm, about 700 μm, about 800 μm, about 900 μm, about 1 mm, about 1.2 mm, about 1.4 mm, about 1.5 mm, about 1.6 mm, about 1.8 mm, about 2 mm, or thicker. For example, any of the separation membranes 100-800 can have a thickness in a range from about 60 μm to about 2 mm, about 60 μm to about 1.5 mm, about 60 μm to about 1.2 mm, about 60 μm to about 800 μm, about 60 μm to about 500 μm, about 60 μm to about 350 μm, about 60 μm to about 200 μm, about 60 μm to about 100 μm, about 200 μm to about 2 mm, about 200 μm to about 1.5 mm, about 200 μm to about 1.2 mm, about 200 μm to about 800 μm, about 200 μm to about 500 μm, about 200 μm to about 350 μm, about 200 μm to about 300 μm, about 200 μm to about 250 μm, about 500 μm to about 2 mm, about 500 μm to about 1.5 mm, about 500 μm to about 1.2 mm, about 500 μm to about 800 μm, about 500 μm to about 600 μm, about 1 mm to about 2 mm, about 1 mm to about 1.8 mm, about 1 mm to about 1.5 mm, about 1 mm to about 1.3 mm, or about 1 mm to about 1.2 mm.

In one or more embodiments, any of the separation membranes 100-800 can be configured, manufactured, or otherwise formed as a flat sheet membrane, a spiral-wound membrane, a hollow fiber membrane, a plate-and-frame membrane, or other types of membranes. In some embodiments, any of the separation membranes 100-400 can be configured, manufactured, or otherwise formed as a flat sheet membrane. In other embodiments, any of the separation membranes 500-800 can be configured, manufactured, or otherwise formed as a hollow fiber membrane.

To characterize the separation performance of a gas separation membrane, there are two important parameters. One is the selectivity (or the separation factor) for two components i and j, which is defined as by the following equation:

$${α}_{ij} = \frac{{y}_{i} / {y}_{j}}{{x}_{i} / {x}_{j}} ,$$

where the xᵢ, xⱼ, yᵢ, yⱼ denote the mole concentration of component i on the feed side, the mole concentration of component j on the feed side, the mole concentration of component i on the permeate side, and the mole concentration of component j on the permeate side, respectively.

In one or more embodiments, each of any of the separation membranes 100-400, the selective layer 140a, the selective layer 140b, the first selective polymeric material, or the second selective polymeric material can be selectively permeable to a targeted gas containing helium, hydrogen (H₂), oxygen (O₂), or any combination thereof. For example, the selective layer 140a and/or the selective layer 140b can be configured to separate helium, hydrogen (H₂), oxygen (O₂), or any combination thereof from a gas mixture containing a base gas and at least one of helium, hydrogen (H₂), oxygen (O₂), or any combination thereof. The base gas can be or contain methane, ethane, ethene, propylene, other hydrocarbon gases, nitrogen (N₂), carbon dioxide, carbon monoxide, hydrogen sulfide, ammonia, water, or any combination thereof. In some examples, the base gas can be or contain air, natural gas, flue gas, syngas, biogas, refinery off-gases, or any combination thereof. The term “base gas” describes the gas before being separated by processes described and discussed herein and includes the targeted gas and the remaining base gas. The term “base gas” is used independently of what the chemical pH value is of the base gas.

In other embodiments, each of any of the separation membranes 100-800, the selective layer 140a, the selective layer 140b, the first selective polymeric material, or the second selective polymeric material can be selectively permeable to a targeted gas containing carbon dioxide, hydrogen sulfide, hydrogen chloride, hydrogen fluoride, nitrogen oxide, sulfur oxide, other acidic compound gases, or any combination thereof. In some examples, the selective layer 140a, the selective layer 140b can be configured to separate carbon dioxide, hydrogen sulfide, hydrogen chloride, hydrogen fluoride, nitrogen oxide, sulfur oxide, or any combination thereof from a gas mixture containing a base gas and at least one of carbon dioxide, hydrogen sulfide, hydrogen chloride, hydrogen fluoride, nitrogen oxide, sulfur oxide, or any combination thereof. The base gas can be or contain methane, on or more hydrocarbon gases, nitrogen (N₂), oxygen (O₂), hydrogen (H₂), argon, helium, carbon monoxide, or any combination thereof. In some examples, the base gas can be or contain air, natural gas, flue gas, syngas, biogas, one or more gases from a refinery, a power plant, a cement plant, a steel plant, or any combination thereof.

In one or more embodiments, the non-woven fabric backing 110 can be or contain one or more materials which include one or more fibers, one or more natural polymers, one or more synthetic polymers, or any combination thereof. For example, the non-woven fabric backing 110 can be or contain a plurality of fibers. The fibers can be or contain one or more materials selected from polyethylene terephthalate, polyester, polypropylene, polyethylene, polyamide, polyimide, fiberglass, cellulose, regenerated cellulose, wood pulp, cotton, wool, carbon, or any combination thereof.

The non-woven fabric backing 110 can have a thickness in a range from about 10 μm, about 100 μm, about 150 μm, about 200 μm, about 250 μm, or about 300 μm to about 350 μm, about 400 μm, about 500 μm, about 600 μm, about 700 μm, about 800 μm, about 900 μm, about 1 mm, or thicker. For example, the non-woven fabric backing 110 can have a thickness in a range from about 10 μm to about 1 mm, about 100 μm to about 1 mm, about 250 μm to about 1 mm, about 500 μm to about 1 mm, about 600 μm to about 1 mm, about 750 μm to about 1 mm, about 900 μm to about 1 mm, about 10 μm to about 750 μm, about 100 μm to about 750 μm, about 250 μm to about 750 μm, about 500 μm to about 750 μm, about 600 μm to about 750 μm, about 10 μm to about 500 μm, about 100 μm to about 500 μm, about 250 μm to about 500 μm, or about 400 μm to about 500 μm.

In one or more embodiments, the porous support layer 120 can be or contain one or more porous polymeric materials. In some examples, the polymeric materials can be or include one or more polyamides, one or more polyimides, one or more polyesters, one or more sulfone-based polymers, one or more polymeric organosilicones, one or more fluorinated polymers, one or more chlorinated polymers, one or more polyacrylonitriles, one or more polybenzimidazoles, one or more cellulose-based polymers, oligomers thereof, complexes thereof, derivatives thereof, or any combination thereof. Exemplary polymeric materials can be or include one or more polysulfones, one or more polyphenylsulfones, one or more polyethersulfones, one or more polydimethylsiloxanes, one or more polytetrafluoroethylenes, one or more polyvinylidene fluorides, one or more polyvinyl chlorides, one or more cellulose acetates, oligomers thereof, complexes thereof, derivatives thereof, or any combination thereof.

The porous support layer 120 can have a thickness in a range from about 10 μm, about 20 μm, about 25 μm, about 30 μm, about 50 μm, about 75 μm, about 90 μm, or about 100 μm to about 120 μm, about 150 μm, about 180 μm, about 200 μm, about 250 μm, about 300 μm, about 350 μm, about 400 μm, about 450 μm, about 500 μm, or thicker. For example, the porous support layer 120 can have a thickness in a range from about 10 μm to about 500 μm, about 10 μm to about 400 μm, about 10 μm to about 350 μm, about 10 μm to about 300 μm, about 10 μm to about 250 μm, about 10 μm to about 200 μm, about 10 μm to about 150 μm, about 10 μm to about 120 μm, about 10 μm to about 100 μm, about 10 μm to about 80 μm, about 10 μm to about 50 μm, about 10 μm to about 35 μm, about 10 μm to about 20 μm, about 50 μm to about 500 μm, about 50 μm to about 400 μm, about 50 μm to about 350 μm, about 50 μm to about 300 μm, about 50 μm to about 250 μm, about 50 μm to about 200 μm, about 50 μm to about 150 μm, about 50 μm to about 120 μm, about 50 μm to about 100 μm, about 50 μm to about 80 μm, about 50 μm to about 65 μm, about 100 μm to about 500 μm, about 100 μm to about 400 μm, about 100 μm to about 350 μm, about 100 μm to about 300 μm, about 100 μm to about 250 μm, about 100 μm to about 200 μm, about 100 μm to about 150 μm, or about 100 μm to about 120 μm.

In one or more embodiments, the porous support layer 120 can have a plurality of pores 122 therethrough. The pores 122 can extend throughout the porous support layer 120. In some examples, the pores 122 extend between the lower and upper surfaces of the porous support layer 120. The plurality of pores 122 can have an average pore size in a range from about 1 nm, about 2 nm, about 5 nm, about 10 nm, about 20 nm, or about 25 nm to about 30 nm, about 40 nm, about 50 nm, about 60 nm, about 80 nm, or about 100 nm (about 0.1 μm), or greater. For example, the average pore size of the pores 122 can be about 1 nm to about 100 nm, about 5 nm to about 100 nm, about 10 nm to about 100 nm, about 20 nm to about 100 nm, about 50 nm to about 100 nm, about 75 nm to about 100 nm, about 1 nm to about 50 nm, about 5 nm to about 50 nm, about 10 nm to about 50 nm, about 20 nm to about 50 nm, about 50 nm to about 35 nm, about 1 nm to about 20 nm, about 2 nm to about 20 nm, about 5 nm to about 20 nm, about 12 nm to about 20 nm, about 15 nm to about 20 nm, or about 18 nm to about 20 nm.

In one or more embodiments, the gutter layer 130 can be or contain one or more materials for leveling and/or smoothing the interface or upper surface of an underlying layer, such as the porous support layer 120. In some embodiments, the gutter layer 130 can be or include a non-porous polymeric layer without pores of greater than 10 Å. The spaces or voids disposed between the polymer chains of the gutter layer 130 are 10 Å or less (e.g., about 1 Å to about 10 Å) in diameter which allows for gas components to non-selectively diffuse through these spaces or voids. The gutter layer 130 can be or contain one or more polymeric organosilicones, one or more fluorinated polymers, one or more polyacrylonitriles, one or more polybenzimidazoles, one or more ethylene vinyl alcohol copolymers, oligomers thereof, complexes thereof, derivatives thereof, or any combination thereof. In some examples, the gutter layer 130 can be or contain polydimethylsiloxane, poly(1-(trimethylsilyl)-1-propyne), polytetrafluoroethylene, polyvinylidene fluoride, oligomers thereof, complexes thereof, derivatives thereof, or any combination thereof.

The gutter layer 130 can have a thickness in a range from about 1 nm, about 50 nm, about 100 nm, about 200 nm, about 500 nm, about 800 nm, about 1 μm, about 2 μm, or about 5 μm to about 8 μm, about 10 μm, about 20 μm, about 30 μm, about 40 μm, about 50 μm, or thicker. For example, the gutter layer 130 can have a thickness a range from about 1 nm to about 50 μm, about 1 nm to about 40 μm, about 1 nm to about 30 μm, about 1 nm to about 20 μm, about 1 nm to about 10 μm, about 1 nm to about 1 μm, about 1 nm to about 500 nm, about 1 nm to about 100 nm, about 1 μm to about 50 μm, about 1 μm to about 40 μm, about 1 μm to about 30 μm, about 1 μm to about 20 μm, or about 1 μm to about 10 μm.

In one or more embodiments, each of the selective layers 140 and/or the selective polymeric materials can independently contain one or more ethylene vinyl alcohol polymeric materials, one or more poly(vinyl alcohol) polymeric materials, one or more amine-containing polymeric materials, or any combination thereof.

Each of the selective layers 140 can independently have a thickness in a range from about 1 nm, about 50 nm, about 100 nm, about 200 nm, about 500 nm, about 800 nm, about 1 μm, about 2 μm, or about 5 μm to about 8 μm, about 10 μm, about 20 μm, about 30 μm, about 40 μm, about 50 μm, about 60 μm, about 70 μm, about 80 μm, about 90 μm, about 100 μm, or thicker. For example, each of the selective layers 140 can independently have a thickness a range from about 1 nm to about 100 μm, about 1 nm to about 80 μm, about 1 nm to about 65 μm, about 1 nm to about 50 μm, about 1 nm to about 40 μm, about 1 nm to about 30 μm, about 1 nm to about 20 μm, about 1 nm to about 10 μm, about 1 nm to about 1 μm, about 1 nm to about 500 nm, about 1 nm to about 100 nm, about 1 nm to about 50 nm, about 500 nm to about 100 μm, about 500 nm to about 80 μm, about 500 nm to about 65 μm, about 500 nm to about 50 μm, about 500 nm to about 40 μm, about 500 nm to about 30 μm, about 500 nm to about 20 μm, about 500 nm to about 10 μm, about 500 nm to about 1 μm, about 1 μm to about 100 μm, about 1 μm to about 80 μm, about 1 μm to about 50 μm, about 1 μm to about 40 μm, about 1 μm to about 30 μm, about 1 μm to about 20 μm, or about 1 μm to about 10 μm.

In some examples, each of the selective layers 140 and/or the selective polymeric materials (e.g., the ethylene vinyl alcohol polymeric material, the poly(vinyl alcohol) polymeric material, the amine-containing polymeric material) can independently contain one or more catalysts. The catalyst can be or contain one or more acids or one or more bases. Exemplary acidic catalysts can be or include hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, or any combination thereof. Exemplary basic catalysts can be or include lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, or any combination thereof.

In one or more examples, each of the selective layers 140 and/or the selective polymeric material can independently contain one or more ethylene vinyl alcohol copolymers. In some examples, the ethylene vinyl alcohol polymeric material contains an ethylene vinyl alcohol copolymer which has an ethylene to vinyl alcohol molar ratio in a range from about 1:19 to about 19:1, about 1:12 to about 12:1, about 1:8 to about 8:1, about 1:6 to about 6:1, about 1:5 to about 5:1, or about 1:4 to about 4:1.

The ethylene vinyl alcohol polymeric material and/or the ethylene vinyl alcohol copolymer can have an ethylene content in a range from about 5 mole percent (mol %), about 10 mol %, about 15 mol %, about 20 mol %, about 25 mol %, about 30 mol %, or about 40 mol % to about 45 mol %, about 50 mol %, about 60 mol %, about 70 mol %, about 80 mol %, about 85 mol %, about 90 mol %, or about 95 mol %. For example, the ethylene vinyl alcohol polymeric material and/or the ethylene vinyl alcohol copolymer can have an ethylene content in a range from about 5 mol % to about 95 mol %, about 5 mol % to about 90 mol %, about 5 mol % to about 80 mol %, about 5 mol % to about 75 mol %, about 5 mol % to about 60 mol %, about 5 mol % to about 50 mol %, about 5 mol % to about 40 mol %, about 5 mol % to about 30 mol %, about 5 mol % to about 25 mol %, about 5 mol % to about 15 mol %, about 5 mol % to about 10 mol %, about 20 mol % to about 95 mol %, about 20 mol % to about 90 mol %, about 20 mol % to about 80 mol %, about 20 mol % to about 75 mol %, about 20 mol % to about 60 mol %, about 20 mol % to about 50 mol %, about 20 mol % to about 40 mol %, about 20 mol % to about 30 mol %, about 20 mol % to about 25 mol %, about 50 mol % to about 95 mol %, about 50 mol % to about 90 mol %, about 50 mol % to about 80 mol %, about 50 mol % to about 75 mol %, or about 50 mol % to about 60 mol %.

In other embodiments, the selective layer 140 can be or contain an ethylene vinyl alcohol polymeric material which is a reaction product prepared from a functional or cross-linking group and/or the selective layer 140 can be or contain a poly(vinyl alcohol) polymeric material which is another reaction product prepared from the functional or cross-linking group. The functional or cross-linking group contains an aldehyde, H(O)CR, having at least one of the chemical formulas represented by the following Formulas (1a)-(1i), respectively, where R is:

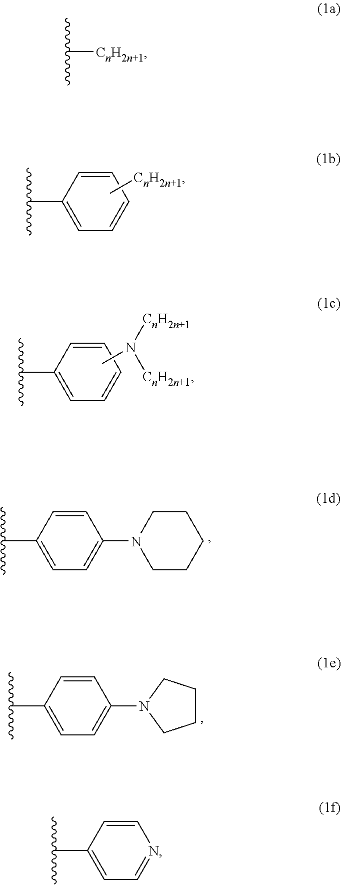

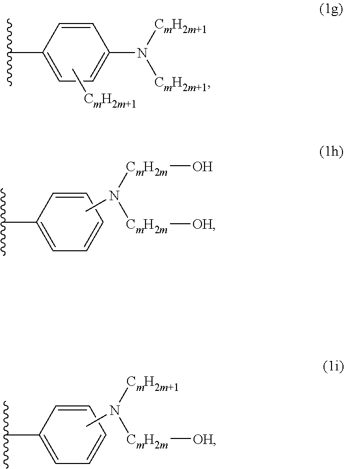

or any combination thereof, and wherein n of Formulas (1a)-(1c) is an integer in a range from 0 to about 18, and m of Formulas (1g)-(1i) is an integer in a range from 1 to about 18.

In some embodiments, the ethylene vinyl alcohol polymeric material can be or contain a reaction product prepared from a functional or cross-linking group and/or the selective layer 140 can be or contain a poly(vinyl alcohol) polymeric material which is another reaction product prepared from the functional or cross-linking group. The functional or cross-linking group contains a dialdehyde having at least one of the chemical formulas represented by Formulas (2a)-(2b), respectively:

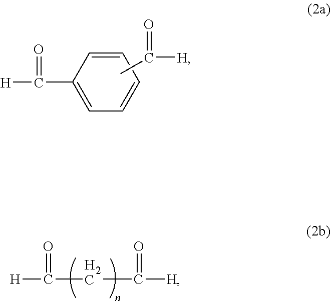

or any combination thereof, wherein n of Formula (2b) is an integer from 1 to about 18.

In one or more embodiments, the ethylene vinyl alcohol polymeric material can be or contain a reaction product prepared from a functional or cross-linking group and/or the selective layer 140 can be or contain a poly(vinyl alcohol) polymeric material which is another reaction product prepared from the functional or cross-linking group. The functional or cross-linking group contains a diepoxide having the following chemical formula represented by Formula (3):

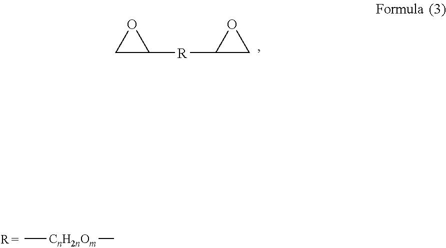

wherein n of Formula (3) is an integer from 0 to about 18, and m of Formula (3) is an integer from 0 to 4.

In other embodiments, one or more of the selective layers 140 contains one or more amine-containing polymeric materials. The amine-containing polymeric material can be or include polymethyleneamine, polyvinylamine, polyallylamine, linear polyethylenimine, branched polyethylenimine, an oligomer thereof, a complex thereof, a derivative thereof, or any combination thereof.

In some examples, the amine-containing polymeric material can be or include one or more reaction products prepared from a functional or cross-linking group. The functional or cross-linking group contains an aldehyde, H(O)CR, having at least one of the chemical formulas represented by the following formulas represented by Formulas (4a)-(4i), respectively, where R is:

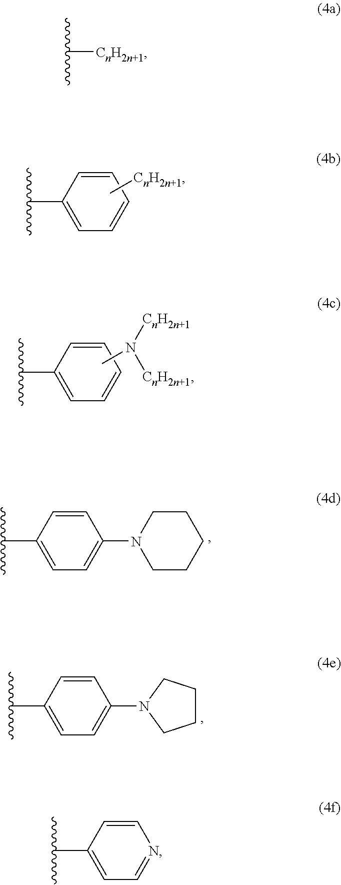

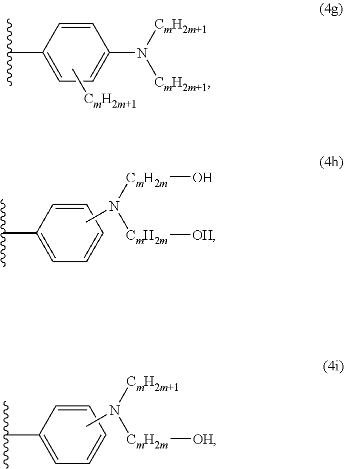

or any combination thereof, where n of Formulas (4a)-(4c) is an integer in a range from 0 to about 18, and each m of Formulas (4g)-(4i) is independently an integer in a range from 1 to about 18.

In other examples, the amine-containing polymeric material can be or include one or more reaction products prepared from a functional or cross-linking group. The functional or cross-linking group contains a dialdehyde having at least one of the chemical formulas represented by Formulas (5a)-(5b), respectively:

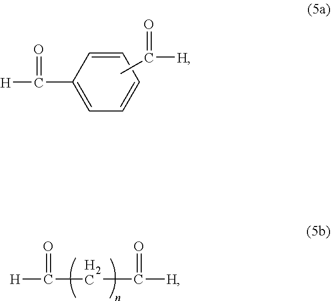

or any combination thereof, wherein n of Formula (5b) is an integer from 1 to about 18.

In some examples, the amine-containing polymeric material can be or include a reaction product prepared from a functional or cross-linking group. The functional or cross-linking group contains a diepoxide having the chemical formula represented by Formula (6):

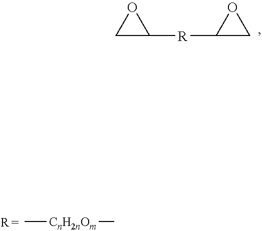

wherein n of Formula (6) is an integer from 0 to about 18, and m of Formula (6) is an integer from 0 to 4.

In one or more embodiments, one or more of the selective layers 140 can be or contain an amine-containing polymeric material containing a reaction product between an epoxide and at least one of: polymethyleneamine, polyvinylamine, polyallylamine, linear polyethylenimine, branched polyethylenimine, an oligomer thereof, a complex thereof, a derivative thereof, or any combination thereof. In some examples, the epoxide can be or contain ethylene oxide, propylene oxide, or a combination thereof. In one or more examples, the reaction product can be produced by combining a molar ratio of the epoxide to amine groups of polymethyleneamine, polyvinylamine, polyallylamine, linear polyethylenimine, branched polyethylenimine, or combinations thereof. The molar ratio can be in a range from about 1:100 to about 20:1 or about 1:10 to about 6:1.

In some examples, the reaction product has at least one of the chemical formulas represented by Formulas (7a)-(7b), respectively:

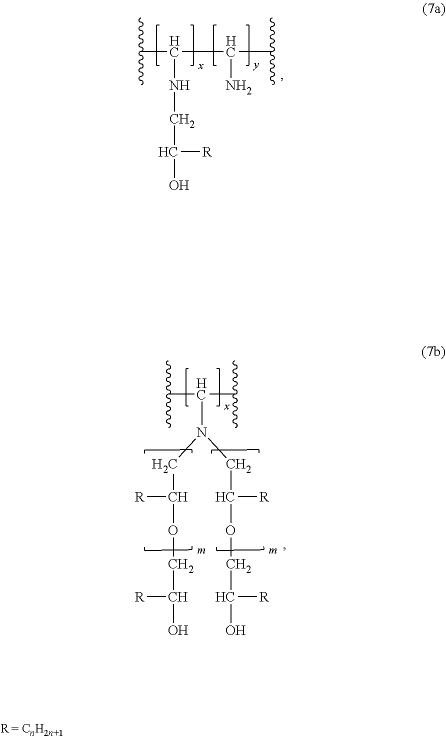

or
any combination thereof, and where x of Formulas (7a)-(7b) is an integer in a range from about 10 to about 1,000,000, y of Formula (7a) is an integer in a range from about 10 to about 1,000,000, n of Formulas (7a)-(7b) is an integer in a range from 0 to about 18, and each m of Formula (7b) is independently an integer in a range from 0 to about 10.

In other examples, the reaction product has at least one of the chemical formulas represented by Formulas (8a)-(8b), respectively:

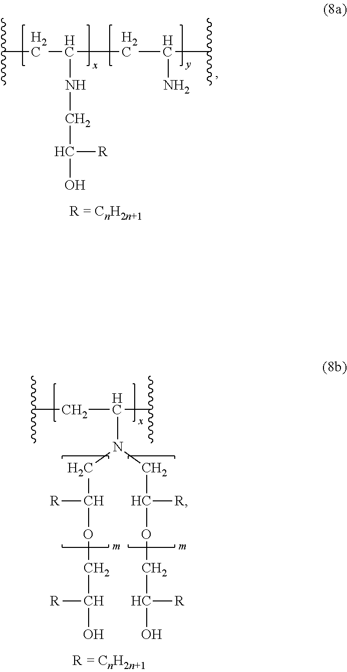

or
any combination thereof, and where x of Formulas (8a)-(8b) is an integer in a range from about 10 to about 1,000,000, y of Formula (8a) is an integer in a range from about 10 to about 1,000,000, n of Formulas (8a)-(8b) is an integer in a range from 0 to about 18, and each m of Formula (8b) is independently an integer in a range from 0 to about 10.

In one or more examples, the reaction product has at least one of the chemical formulas represented by Formulas (9a)-(9b), respectively:

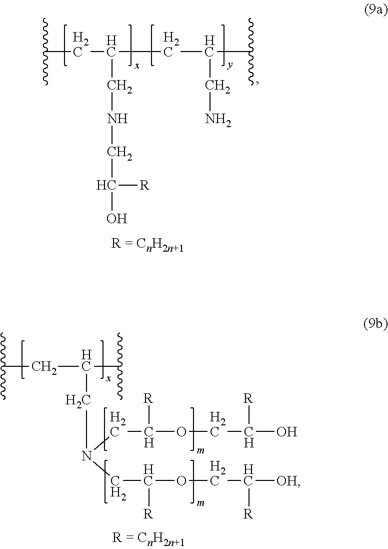

or
any combination thereof, and where x of Formulas (9a)-(9b) is an integer in a range from about 10 to about 1,000,000, y of Formula (9a) is an integer in a range from about 10 to about 1,000,000, n of Formulas (9a)-(9b) is an integer in a range from 0 to about 18, and each m of Formula (9b) is independently an integer in a range from 0 to about 10.

In other examples, the reaction product has at least one of the chemical formulas represented by Formulas (10a)-(10b), respectively:

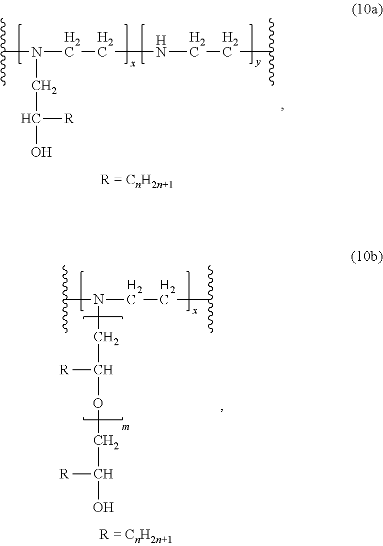

or
any combination thereof, where x of Formulas (10a)-(10b) is an integer in a range from about 10 to about 1,000,000, y of Formula (10a) is an integer in a range from about 10 to about 1,000,000, n of Formulas (10a)-(10b) is an integer in a range from 0 to about 18, and m of Formula (10b) is an integer in a range from 0 to about 10.

In some examples, the reaction product has at least one of the chemical formulas represented by Formulas (11a)-(11b), respectively:

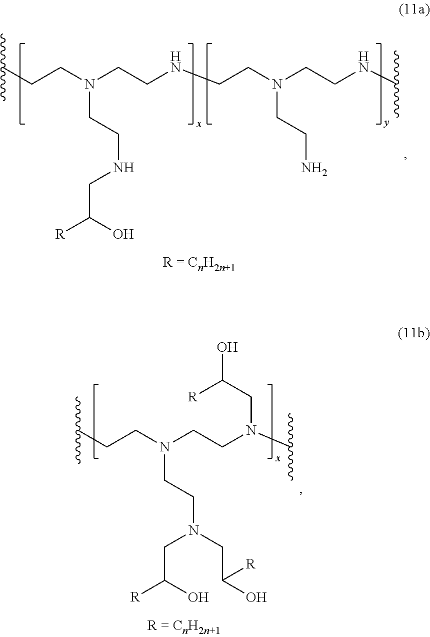

or
any combination thereof, wherein x of Formulas (11a)-(11b) is an integer in a range from about 10 to about 1,000,000, y of Formula (11a) is an integer in a range from about 10 to about 1,000,000, and n of Formulas (11a)-(11b) is an integer in a range from 0 to about 18.

In one or more examples, the reaction product can be produced with a catalyst, where the catalyst can be or contain one or more acids or one or more bases, as described and discussed above. Also, the reaction product can be produced with an epoxide, such as ethylene oxide, propylene oxide, or a combination thereof. The catalyst and the epoxide can be added together at a catalyst to epoxide weight ratio in a range from about 1:100,000 to about 1 to 1, or in other examples, in a range from about 1:9,999 to about 1 to 1.

Each of the ethylene vinyl alcohol polymeric material, the ethylene vinyl alcohol copolymer, or the poly(vinyl alcohol) polymeric material can independently have a weight average molecular weight of greater than 500 Daltons, about 1,000 Daltons, about 10,000 Daltons, about 100,000 Daltons, about 500,000 Daltons, or about 1,000,000 Daltons to about 1,500,000 Daltons, about 2,000,000 Daltons, about 3,000,000 Daltons, about 4,000,000 Daltons, about 5,000,000 Daltons, about 5,500,000 Daltons, or less than 6,000,000 Daltons. For example, each of the ethylene vinyl alcohol polymeric material, the ethylene vinyl alcohol copolymer, or the poly(vinyl alcohol) polymeric material can independently have a weight average molecular weight of greater than 500 Daltons and less than 6,000,000 Daltons, about 1,000 Daltons and less than 6,000,000 Daltons, about 100,000 Daltons and less than 6,000,000 Daltons, about 1,000,000 Daltons and less than 6,000,000 Daltons, about 2,000,000 Daltons and less than 6,000,000 Daltons, about 3,000,000 Daltons and less than 6,000,000 Daltons, about 4,000,000 Daltons and less than 6,000,000 Daltons, or about 5,000,000 Daltons and less than 6,000,000 Daltons.

### Examples

In order to provide a better understanding of the foregoing discussion, the following non-limiting examples are offered. Although the examples can be directed to specific embodiments, they are not to be viewed as limiting the invention or claimed subject matter in any specific respect.

The synergetic effects due to the separation membranes described and discussed herein have been achieved. The separation membranes can be prepared as highlighted by the following Examples 1-16.

Example 1: One composite membrane is suitable for (1) the separation of helium from raw natural gas which contained methane, ethane, carbon dioxide, helium, hydrogen sulfide, nitrogen, and water; (2) the separation of hydrogen (H₂) from gas mixtures which include hydrogen, methane, ethane, carbon dioxide, carbon monoxide, oxygen (O₂), hydrogen sulfide, nitrogen, ammonia, water, ethylene, propylene, and combinations thereof; and (3) the separation of oxygen from air or flue gases. The composite membrane contains (a) a non-woven fabric backing containing of polyester or polypropylene; (b) a porous support layer containing of polysulfone or polyethersulfone with average pore size from about 10 nm to about 0.1 μm; and (c) one non-porous selective layer containing of an ethylene vinyl alcohol copolymer with thickness in a range from about 50 nm to about 50 μm. The membrane's selective layer is selectively permeable to helium, hydrogen, or oxygen. During the preparation of the casting solution, an ethylene vinyl alcohol copolymer is dissolved in a solvent or a solvent mixture. Then gas bubbles and solid particles are removed from the casting solution with a centrifuge, and the casting solution is coated on the porous support layer via the “knife casting” method. The composite membrane is then heated to about 50° C. to about 160° C. for a period in a range from about 5 minutes to about 60 minutes to remove the solvent.

Example 2: One composite membrane is prepared in the configuration of hollow fibers. The composite membrane is suitable for (1) the separation of helium from raw natural gas which contained methane, ethane, carbon dioxide, hydrogen sulfide, helium, nitrogen, and water; (2) the separation of hydrogen (H₂) from gas mixtures which include hydrogen, methane, ethane, carbon dioxide, carbon monoxide, oxygen (O₂), hydrogen sulfide, nitrogen, ammonia, ethylene, propylene, water, and combinations thereof; and (3) the separation of oxygen from air or flue gases. The composite membrane contains (a) a porous hollow fiber support membrane with average pore size from about 10 nm to about 0.1 μm and outside diameter ranging from about 20 μm to about 3 mm; and (b) one non-porous selective layer containing of an ethylene vinyl alcohol copolymer with thickness in a range from about 50 nm to about 50 μm. The membrane's selective layer is selectively permeable to helium, hydrogen, or oxygen. The selective layer is either coated on the outside or the inside of the hollow fiber membrane. During the preparation of the casting solution, the ethylene vinyl alcohol copolymer is dissolved in a solvent or a solvent mixture. Then gas bubbles and solid particles are removed from the casting solution with a centrifuge, and the casting solution is coated on the hollow fiber porous support layer via the “dip casting” method. The composite membrane is then heated with hot air at about 50° C. to about 160° C. for a period in a range from about 5 minutes to about 60 minutes to remove the solvent.

Example 3: One composite membrane is suitable for separating acid gases including carbon dioxide, hydrogen sulfide, nitrogen oxide, and sulfur oxide from gas mixtures that included (1) raw natural gas; (2) flue gas; (3) syngas; and (4) biogas that contained carbon dioxide and hydrogen sulfide. The composite membrane contained (a) a polyester or polypropylene non-woven fabric backing; (b) a polysulfone or polyethersulfone porous support layer with average pore size from about 10 nm to about 0.1 μm; (c) one non-porous layer containing of an ethylene vinyl alcohol copolymer. The non-porous layer had a thickness in a range from about 10 nm to about 50 μm. During the preparation of the composite membrane, an ethylene vinyl alcohol copolymer is dissolved in a solvent and an aldehyde cross-linking agent and a base catalyst are added to partially cross-link the ethylene vinyl alcohol copolymer at elevated temperatures ranging from about 35° C. to about 199° C. for about 1 hour to about 3 hours. Then gas bubbles and solid particles are removed from the casting solution with a centrifuge, the casting solution is coated on the porous support layer with “knife casting”. The composite membrane is then heated to about 60° C. to about 160° C. for a period in a range from about 5 minutes to about 60 minutes to remove the solvent and complete the cross-linking.

Example 4: One composite hollow fiber membrane is suitable for separating acid gases including carbon dioxide, hydrogen sulfide, nitrogen oxide, and sulfur oxide from (1) raw natural gas; (2) flue gas; (3) syngas; and (4) biogas that contained carbon dioxide and hydrogen sulfide. The membrane's selective layer is selectively permeable to acid gases including carbon dioxide, hydrogen sulfide, nitrogen oxide, and sulfur oxide. The composite membrane contains (a) a polysulfone or polyethersulfone porous hollow fiber support membrane with average pore size from about 10 nm to about 0.1 μm, and (b) one non-porous selective layer containing of an ethylene vinyl alcohol copolymer. The non-porous layer has a thickness in a range from about 10 nm to about 50 μm, and is coated either inside the hollow fiber or outside the hollow fiber. During the preparation of the casting solution, an ethylene vinyl alcohol copolymer is dissolved, then an aldehyde cross-linking agent and a catalyst are added to partially cross-link ethylene vinyl alcohol copolymer. Then gas bubbles and solid particles are removed from the casting solution with a centrifuge. A hollow fiber is continuously dipped and pulled out from the container with the casting solution so that the casting solution is coated on the outside of the hollow fiber via the “dip casting” method. Alternatively, the casting solution is coated on the inside of the hollow fiber by flowing the casting solution through the hollow fiber. The composite hollow fiber membrane is then heated to about 60° C. to about 160° C. for a period in a range from about 5 minutes to about 60 minutes to remove the solvent and complete the cross-linking.

Example 5: One composite membrane is suitable for separating acid gases including carbon dioxide and hydrogen sulfide from gas mixtures that included (1) raw natural gas; (2) flue gas; (3) syngas; and (4) biogas that contained carbon dioxide and hydrogen sulfide. The composite membrane contained (a) a polyester or polypropylene non-woven fabric backing; (b) a polysulfone or polyethersulfone porous support layer with average pore size from about 10 nm to about 0.1 μm; (c) one non-porous gutter layer containing of an ethylene vinyl alcohol copolymer; and (d) one non-porous selective layer with an ethylene vinyl alcohol copolymer and a linear polyethylenimine. The non-porous layers have a thickness in a range from about 10 nm to about 100 μm. During the preparation of the composite membrane, an ethylene vinyl alcohol copolymer is dissolved in a solvent and the solution is coated onto the porous support layer as the gutter layer. After the first casting solution is at least partially dried. The second casting solution is prepared by dissolving an ethylene vinyl alcohol copolymer and linear polyethylenimine in a solvent mixture, then an aldehyde cross-linking agent and a base catalyst are added to partially cross-link the ethylene vinyl alcohol copolymer and the linear polyethylenimine. Then gas bubbles and solid particles are removed from the second casting solution with a centrifuge, and the second casting solution is coated on the non-porous gutter layer. The composite membrane is then heated to about 60° C. to about 160° C. for a period in a range from about 5 minutes to about 60 minutes to remove the solvent and complete the cross-linking.

Example 6: One composite membrane is prepared for separating acid gases including carbon dioxide and hydrogen sulfide from gas mixtures that included (1) raw natural gas; (2) flue gas; (3) biogas; (4) syngas; and (5) air. The composite membrane contains (a) a polyester or polypropylene non-woven fabric backing; (b) a polysulfone or polyethersulfone porous support layer with average pore size from about 10 nm to about 0.1 μm; and (c) one non-porous selective layer containing partially cross-linked ethylene vinyl alcohol copolymer and chemically modified branched polyethylenimine. The ethylene vinyl alcohol copolymer and chemically modified branched polyethylenimine weight ratio is about 5 to 1 to about 3 to 1. The non-porous layer has a thickness in a range from about 10 nm to about 100 μm. During the preparation of the composite membrane, an ethylene vinyl alcohol copolymer and chemically modified branched polyethylenimine are dissolved in a solvent mixture at about 70° C. to about 100° C. Then, a diepoxide cross-linking agent and a base catalyst is mixed into this solution. The solution is kept with agitation at about 20° C. to about 80° C. until the solution viscosity reaches a target. Then the heating and agitation are stopped. The gas bubbles and solid particles are removed from the resulting solution with a centrifuge, the resulting casting solution is coated on the porous support layer with a non-woven fabric backing. The composite membrane is then heated to about 60° C. to about 160° C. for a period in a range from about 5 minutes to about 60 minutes to remove the solvent and complete the cross-linking.

Example 7: One composite membrane is prepared for separating acid gases including carbon dioxide and hydrogen sulfide from gas mixtures that included (1) raw natural gas; (2) flue gas; (3) biogas; (4) syngas; and (5) air. The composite membrane contained (a) a polyester or polypropylene non-woven fabric backing; (b) a polysulfone or polyethersulfone porous support layer with average pore size from about 10 nm to about 0.1 μm; and (c) one non-porous selective layer with chemically modified polyvinylamine. The non-porous layer has a thickness in a range from about 10 nm to about 100 μm. During the preparation of the composite membrane, polyvinylamine is dissolved in a solvent. An epoxide such as ethylene oxide or propylene oxide is added into this solution, and the reaction is completed at about 100° C. to about 150° C. for about 1 hour to about 3 hours. Then, a diepoxide is added to partially crosslink the chemically modified polyvinylamine. Gas bubbles and solid particles are removed from the resulting solution with a centrifuge, the resulting casting solution is coated on the porous support layer. The composite membrane is then heated to about 60° C. to about 160° C. for a period in a range from about 5 minutes to about 60 minutes to remove the solvent and complete the cross-linking.

Example 8: One composite hollow fiber membrane is suitable for separating acid gases including carbon dioxide, hydrogen sulfide, nitrogen oxide, and/or sulfur oxide from (1) raw natural gas; (2) flue gas; (3) biogas; (4) syngas; and (5) air. The membrane's selective layer is selectively permeable to acid gases including carbon dioxide, hydrogen sulfide, nitrogen oxide, and sulfur oxide. The composite membrane contains (a) a polysulfone or polyethersulfone porous hollow fiber support membrane with average pore size from about 10 nm to about 0.1 μm, and (b) one non-porous selective layer containing of a chemically modified polyvinylamine. The non-porous layer has a thickness in a range from about 10 nm to about 100 μm, and is coated either inside the hollow fiber or outside the hollow fiber. During the preparation of the composite membrane, polyvinylamine is dissolved in a solvent or a solvent mixture. An epoxide such as ethylene oxide or propylene oxide is added into this solution, and the reaction is completed at about 100° C. to about 150° C. for about 1 hour to about 3 hours. Then, a diepoxide is added to increase the solution viscosity and partially crosslink the chemically modified polyvinylamine. Then gas bubbles and solid particles are removed from the casting solution with a centrifuge. A hollow fiber is continuously pulled out from the container with the casting solution so that the casting solution is coated on the outside of the hollow fiber via the “dip casting” method. Alternatively, the casting solution is coated on the inside of the hollow fiber by flowing the casting solution through the hollow fiber. The composite hollow fiber membrane is then heated to about 60° C. to about 160° C. for a period in a range from about 5 minutes to about 60 minutes to remove the solvent and complete the cross-linking.

Example 9: One composite membrane is suitable for separating acid gases including carbon dioxide and hydrogen sulfide from gas mixtures that includes (1) raw natural gas; (2) flue gas; (3) biogas; (4) syngas; and (5) air. The composite membrane contained (a) a polyester or polypropylene non-woven fabric backing; (b) a polysulfone or polyethersulfone porous support layer with average pore size from about 10 nm to about 0.1 μm; (c) one non-porous layer containing of chemically modified and cross-linked poly(vinyl alcohol) and polymethyleneamine with weight average molecular weight of greater than 160,000 Daltons; and (d) one non-porous selective layer containing of a cross-linked ethylene vinyl alcohol copolymer with weight average molecular weight in a range from about 160,000 Daltons to about 5,000,000 Daltons. The non-porous layer has a thickness in a range from about 10 nm to about 100 μm. During the preparation of the casting solution of the first selective layer (c), poly(vinyl alcohol) and polymethyleneamine are dissolved in a solvent, and an aldehyde cross-linking agent and a base catalyst are used to partially cross-link and chemically modified poly(vinyl alcohol) and polymethyleneamine. The casting solution is kept at elevated temperatures ranging from about 65° C. to about 90° C. After the viscosity of the casting solution increases and reaches the desired range, which indicates the molecular weight increases to greater than 160,000 Daltons, the heating is stopped. Then gas bubbles and solid particles are removed from the casting solution with a centrifuge. The casting solution is coated on the porous support layer. The composite membrane is then heated to about 60° C. to about 120° C. for a period in a range from about 5 minutes to about 60 minutes to remove most of the solvent. The second casting solution is prepared by dissolving an ethylene vinyl alcohol copolymer and in a solvent, then an aldehyde cross-linking agent and a base catalyst are used to partially cross-link ethylene vinyl alcohol copolymer. Then the second casting solution is coated on the first selective layer. The composite membrane is then heated to about 60° C. to about 120° C. for a period in a range from about 5 minutes to about 60 minutes to remove the remaining solvents and complete the cross-linking.

Example 10: The composite membranes prepared from Example 1 and Example 2 are used for the separation of helium from raw natural gas which contained methane, ethane, carbon dioxide, hydrogen sulfide, helium, nitrogen, and water. In this separation process, the raw natural gas enters a membrane unit on the high-pressure or high-concentration feed side. Due to the selectivity of the composite membrane, helium permeates through the membrane to the low pressure permeate side at a greater transport rate than other gas components. As the result, helium is enriched on the low pressure permeate side, while the other components become concentrated on the feed side. The low pressure on the permeate side is maintained using a vacuum pump. The permeated helium is pressurized and further purified.

Example 11: The composite membranes prepared from Example 1 and Example 2 are used for the separation of hydrogen (H₂) from the syngas which mainly contained hydrogen, carbon dioxide, carbon monoxide, and water. In this separation process, the syngas enters a membrane unit on the high-pressure or high-concentration feed side. Due to the selectivity of the composite membrane, hydrogen permeates through the membrane to the low pressure permeate side at a greater transport rate than other gas components. As the result, hydrogen is enriched on the low pressure permeate side, while the other components become concentrated on the feed side. The low pressure on the permeate side is maintained using a vacuum pump. The permeated hydrogen is pressurized and further purified.

Example 12: The composite membranes prepared from Example 1 and Example 2 are used for the separation of oxygen (O₂) from air or flue gases. In this separation process, air or flue gases enters a membrane unit on the high-pressure or high-concentration feed side. Due to the selectivity of the composite membrane, oxygen permeates through the membrane to the low pressure permeate side at a greater transport rate than other gas components. As the result, oxygen is enriched on the low pressure permeate side, and is depleted on the feed side. The low pressure on the permeate side is maintained using a vacuum pump. The air from the feed side had oxygen depleted, therefore, is used as inert atmosphere whenever oxygen would pose a fire, explosion, or oxidizing hazard. The flue gas from the feed side had oxygen depleted, therefore, is used as carbon dioxide feedstock in chemical reactions without concern for a fire, explosion, or oxidizing hazard.

Example 13: The composite membranes prepared from Example 1 and Example 2 are used for the separation of carbon dioxide and hydrogen sulfide from the raw natural gas which mainly contained methane, ethane, carbon dioxide, hydrogen sulfide, nitrogen, and water. In this separation process, the raw natural gas enters a membrane unit on the high-pressure or high-concentration feed side. Due to the selectivity of the composite membrane, hydrogen sulfide and carbon dioxide permeate through the membrane to the low pressure permeate side at a greater transport rate than other gas components. As the result, hydrogen sulfide and carbon dioxide are removed from the feed side. The low partial pressure of hydrogen sulfide and carbon dioxide on the permeate side is maintained using a vacuum pump or a sweep gas. The permeated hydrogen sulfide and carbon dioxide is pressurized and further purified.

Example 14: The composite membranes prepared from Examples 3-9 are used for the removal of carbon dioxide and hydrogen sulfide from the raw syngas which contained hydrogen (H₂), carbon dioxide, hydrogen sulfide, carbon monoxide, and water. In this separation process, the raw syngas enters a membrane unit on the high-pressure or high-concentration feed side. It is optional to add additional water or steam to the feed side. Due to the selectivity of the composite membrane, hydrogen sulfide, water, and carbon dioxide permeate through the membrane to the low pressure permeate side at a greater transport rate than other gas components. As the result, hydrogen sulfide, water, and carbon dioxide are removed from the feed side, and the remaining syngas is kept at the high-pressure feed side. The low partial pressure of hydrogen sulfide and carbon dioxide on the permeate side is maintained using a vacuum pump or a sweep gas. The permeated hydrogen sulfide and carbon dioxide is pressurized and further purified. The permeated water is condensed, recycled to the feed side, and re-used.

Example 15: The composite membranes prepared from Examples 3-9 are used for the removal of carbon dioxide from air. In this separation process, air enters a membrane unit on the high-pressure or high-concentration feed side. It is optional to add additional water or steam to the feed side. Due to the selectivity of the composite membrane, carbon dioxide and water permeate through the membrane to the low pressure permeate side at a greater transport rate than other gas components such as oxygen (O₂) and nitrogen (N₂). As the result, carbon dioxide and water are removed from the air. The removal of carbon dioxide directly from air is often referred to as direct air capture. The low partial pressure of carbon dioxide on the permeate side is maintained using a vacuum pump or a sweep gas. Air or steam is used as the sweep gas. The permeated carbon dioxide is pressurized and further purified using additional membrane stages using the same composite membranes. The permeated water is condensed, recycled to the feed side, and re-used. When using air as the sweep gas, the carbon dioxide in the sweep air is enriched to a level significantly greater than the typical carbon dioxide level, currently around 420 ppm, in the atmosphere. Increasing carbon dioxide level is a proven technique to increase crop yield in controlled environment agriculture such as greenhouses. Using the composite membranes from the present invention can produce air with carbon dioxide level from about 500 ppm to about 0.1%, or from about 600 ppm and to about 1,500 ppm for the application in the controlled environment agriculture such as greenhouses. If the permeated carbon dioxide needs to be used for enhanced oil recovery or permeant underground storage, a process with the composite membranes in several stages may be used to concentrate the permeated carbon dioxide to a required concentration.

Example 16: The composite membranes prepared from Example 1-9 are used for the removal of carbon dioxide, sulfur oxide, and nitrogen oxide from exhaust gases from a fireplace, oven, furnace, boiler, steam generator, power plant, concrete plant, and steel plant. The exhaust gases from these sources all contain carbon dioxide, sulfur oxide, and nitrogen oxide. The exhaust gas from power plants is often referred to as the flue gas. In this separation process, the exhaust gases are first cooled to about 10° C. to about 150° C., then enter a membrane unit on the high-pressure or high-concentration feed side. It is optional to add additional water or steam to the feed side. Due to the selectivity of the composite membrane, carbon dioxide, sulfur oxide, nitrogen oxide, and water permeate through the membrane to the low pressure permeate side at a greater transport rate than other gas components such as nitrogen. As the result, carbon dioxide, sulfur oxide, nitrogen oxide, and water are removed from the exhaust gases. The low partial pressure of carbon dioxide on the permeate side is maintained using a vacuum pump or a sweep gas. Steam is used as the sweep gas. The permeated water is condensed, recycled to the feed side, and re-used. If the permeated carbon dioxide needs to be used for enhanced oil recovery or permeant underground storage, a process with the composite membranes in several stages may be used to concentrate the permeated carbon dioxide to a required concentration. The permeated sulfur oxide and nitrogen oxide are treated with known methods.

Example 17: The composite membranes prepared from Example 1-9 are used to remove carbon dioxide from the air outside a greenhouse and to increase the concentration of carbon dioxide inside the greenhouse with the captured carbon dioxide. The increased concentration of carbon dioxide inside the greenhouse promotes the growth of the plants, fruits, and vegetables inside the greenhouse. In this gas separation process, the outside air is first pressurized to an absolute pressure of about 16 pounds per square inch (psi) to about 294 psi, then enters a membrane unit on the high-pressure feed side. Due to the selectivity of the composite membrane, carbon dioxide permeates through the membrane to the low-pressure permeate side at a greater transport rate than other gas components such as nitrogen and oxygen. The low partial pressure of carbon dioxide on the permeate side is maintained using a sweep gas, which is either the air inside the greenhouse and/or the air outside of the greenhouse. As the result, the carbon dioxide concentration inside the greenhouse is increased in order to promote the growth of the plants, fruits, and vegetables inside the greenhouse. The volume ratio of the permeated carbon dioxide to the additional or sweep air is in a range from about 1 to 10,000 and to about 10 to 1, or in some examples, the carbon dioxide is mixed with additional or sweep air at a volume ratio of the permeated carbon dioxide to the additional or sweep air in a range from about 1 to 100 to about 100 to 1 to produce a gas mixture. The gas mixture is introduced into the greenhouse, produced inside of the greenhouse, or a combination thereof. The carbon dioxide concentration of the gas mixture leaving the permeate side of the membrane unit is about 500 parts per million (ppm) to about 10,000 ppm.

Embodiments of the present disclosure further relate to any one or more of the following Embodiments 1-91:

1. A separation membrane, comprising: a non-woven fabric backing; a porous support layer disposed on the non-woven fabric backing; a gutter layer disposed on the porous support layer; and one or more selective layers disposed on or above the gutter layer, wherein each of the selective layers independently comprises a selective polymeric material, wherein at least one of the selective layers comprises an ethylene vinyl alcohol polymeric material as the selective polymeric material.

2. A separation membrane, comprising: a non-woven fabric backing; a porous support layer disposed on the non-woven fabric backing; and one or more selective layers disposed on or above the porous support layer, wherein each of the selective layers independently comprises a selective polymeric material, wherein at least one of the selective layers comprises an ethylene vinyl alcohol polymeric material as the selective polymeric material.

3. A separation membrane, comprising: a non-woven fabric backing; a porous support layer disposed on the non-woven fabric backing; a gutter layer disposed on the porous support layer; a first selective layer disposed on the gutter layer and comprising a first selective polymeric material; and a second selective layer disposed on the first selective layer, wherein the second selective layer comprises a second selective polymeric material, wherein the first selective polymeric material, the second selective polymeric material, or both the first and second selective polymeric materials comprises an ethylene vinyl alcohol polymeric material.

4. A separation membrane, comprising: a non-woven fabric backing; a porous support layer disposed on the non-woven fabric backing; a first selective layer disposed on the porous support layer and comprising a first selective polymeric material; and a second selective layer disposed on the first selective layer and comprising a second selective polymeric material, wherein the first selective polymeric material, the second selective polymeric material, or both the first and second selective polymeric materials comprises an ethylene vinyl alcohol polymeric material.

5. A separation membrane, comprising: a porous support layer; a gutter layer disposed on the porous support layer; and one or more selective layers disposed on or above the gutter layer, wherein each of the selective layers independently comprises a selective polymeric material, wherein at least one of the selective layers comprises an ethylene vinyl alcohol polymeric material as the selective polymeric material.

6. A separation membrane, comprising: a porous support layer; and one or more selective layers disposed on or above the porous support layer, wherein each of the selective layers independently comprises a selective polymeric material, wherein at least one of the selective layers comprises an ethylene vinyl alcohol polymeric material as the selective polymeric material.

7. A separation membrane, comprising: a porous support layer; a gutter layer disposed on the porous support layer; a first selective layer disposed on the gutter layer and comprising a first selective polymeric material; and a second selective layer disposed on the first selective layer, wherein the second selective layer comprises a second selective polymeric material, wherein the first selective polymeric material, the second selective polymeric material, or both the first and second selective polymeric materials comprises an ethylene vinyl alcohol polymeric material.

8. A separation membrane, comprising: a porous support layer; a first selective layer disposed on the porous support layer and comprising a first selective polymeric material; and a second selective layer disposed on the first selective layer and comprising a second selective polymeric material, wherein the first selective polymeric material, the second selective polymeric material, or both the first and second selective polymeric materials comprises an ethylene vinyl alcohol polymeric material.

9. The separation membrane according to any one of Embodiments 1-8, wherein the separation membrane has a thickness in a range from about 60 μm to about 2 mm.

10. The separation membrane according to any one of Embodiments 1-8, wherein the first selective polymeric material is selectively permeable to a targeted gas comprising helium, hydrogen (H₂), oxygen (O₂), or any combination thereof.

11. The separation membrane according to any one of Embodiments 1-8, wherein each of the one or more selective layers and/or the first selective layer is independently configured to separate helium, hydrogen (H₂), oxygen (O₂), or any combination thereof from a gas mixture comprising a base gas and at least one of helium, hydrogen (H₂), oxygen (O₂), or any combination thereof.

12. The separation membrane of Embodiment 11, wherein the base gas comprises a substance selected from the group consisting of methane, ethane, ethene, propylene, other hydrocarbon gases, nitrogen (N₂), carbon dioxide, carbon monoxide, hydrogen sulfide, ammonia, water, and any combination thereof.

13. The separation membrane of Embodiment 11, wherein the base gas comprises air, natural gas, flue gas, syngas, biogas, refinery off-gases, or any combination thereof.

14. The separation membrane according to any one of Embodiments 1-4, wherein the separation membrane is configured as a flat sheet membrane, a spiral-wound membrane, a hollow fiber membrane, or a plate-and-frame membrane.

15. The separation membrane according to any one of Embodiments 5-8, wherein the selective polymeric material is selectively permeable to a targeted gas comprising a substance selected from the group consisting of carbon dioxide, hydrogen sulfide, hydrogen chloride, hydrogen fluoride, nitrogen oxide, sulfur oxide, and any combination thereof.

16. The separation membrane according to any one of Embodiments 1-8, wherein each of the one or more selective layers and/or the first selective layer is independently configured to separate carbon dioxide, hydrogen sulfide, hydrogen chloride, hydrogen fluoride, nitrogen oxide, sulfur oxide, or any combination thereof from a gas mixture comprising a base gas and at least one of carbon dioxide, hydrogen sulfide, hydrogen chloride, hydrogen fluoride, nitrogen oxide, sulfur oxide, or any combination thereof.

17. The separation membrane of Embodiment 16, wherein the base gas comprises a substance selected from the group consisting of methane, a hydrocarbon gas, nitrogen (N₂), oxygen (O₂), hydrogen (H₂), argon, helium, carbon monoxide, and any combination thereof.

18. The separation membrane of Embodiment 16, wherein the base gas comprises a gas selected from the group consisting of air, natural gas, flue gas, syngas, biogas, one or more gases from a refinery, a power plant, a cement plant, a steel plant, and any combination thereof.

19. The separation membrane according to any one of Embodiments 5-8, wherein the separation membrane is a hollow fiber membrane.

20. The separation membrane according to any one of Embodiments 1-4, wherein the non-woven fabric backing has a thickness in a range from about 10 μm to about 1 mm.

21. The separation membrane according to any one of Embodiments 1-4, wherein the non-woven fabric backing comprises a plurality of fibers, and wherein the fibers comprise a substance selected from the group consisting of polyethylene terephthalate, polyester, polypropylene, polyethylene, polyamide, polyimide, fiberglass, cellulose, regenerated cellulose, wood pulp, cotton, wool, carbon, and any combination thereof.

22. The separation membrane according to any one of Embodiments 1-8, wherein the porous support layer has a thickness in a range from about 10 μm to about 500 μm.

23. The separation membrane according to any one of Embodiments 1-8, wherein the porous support layer comprises a plurality of pores having an average pore size in a range from about 1 nm to about 0.1 μm.

24. The separation membrane according to any one of Embodiments 1-8, wherein the porous support layer comprises a porous polymeric material selected from the group consisting of a polyamide, a polyimide, a polyester, a sulfone-based polymer, a polymeric organosilicone, a fluorinated polymer, a polyvinyl chloride, a chlorinated polymer, a polyacrylonitrile, a polybenzimidazole, a cellulose-based polymer, oligomers thereof, complexes thereof, derivatives thereof, and any combination thereof.

25. The separation membrane of Embodiment 24, wherein the porous polymeric material a material selected from the group consisting of polysulfone, polyphenylsulfone, polyethersulfone, polydimethylsiloxane, polytetrafluoroethylene, polyvinylidene fluoride, polyvinyl chloride, chlorinated polyvinyl chloride, cellulose acetate, oligomers thereof, complexes thereof, derivatives thereof, and any combination thereof.

26. The separation membrane according to any one of Embodiments 1-8, wherein the gutter layer has a thickness in a range from about 1 nm to about 50 μm, and/or wherein the gutter layer is a non-porous layer.

27. The separation membrane according to any one of Embodiments 1-8, wherein the gutter layer comprises a material selected from the group consisting of a polymeric organosilicone, a fluorinated polymer, a polyacrylonitrile, a polybenzimidazole, an ethylene vinyl alcohol copolymer, oligomers thereof, complexes thereof, derivatives thereof, and any combination thereof.

28. The separation membrane according to any one of Embodiments 1-8, wherein the gutter layer comprises a material selected from the group consisting of polydimethylsiloxane, poly(1-(trimethylsilyl)-1-propyne), polytetrafluoroethylene, polyvinylidene fluoride, oligomers thereof, complexes thereof, derivatives thereof, and any combination thereof.

29. The separation membrane according to any one of Embodiments 1-8, wherein each of the one or more selective layers, the first selective layer, and/or the second selective layer independently has a thickness in a range from about 1 nm to about 100 μm, and/or wherein each of the one or more selective layers, the first selective layer, and/or the second selective layer is independently a non-porous layer.

30. The separation membrane according to any one of Embodiments 1-8, wherein each of the one or more selective layers, the first selective layer, and/or the second selective layer independently comprises an ethylene vinyl alcohol copolymer.

31. The separation membrane according to any one of Embodiments 1-8, wherein the ethylene vinyl alcohol polymeric material comprises an ethylene vinyl alcohol copolymer which has an ethylene to vinyl alcohol molar ratio in a range from about 1:19 to about 19:1.

32. The separation membrane according to any one of Embodiments 1-8, wherein the ethylene vinyl alcohol polymeric material comprises an ethylene vinyl alcohol copolymer which has an ethylene to vinyl alcohol molar ratio in a range from about 1:4 to about 4:1.

33. The separation membrane according to any one of Embodiments 1-8, wherein the ethylene vinyl alcohol polymeric material has an ethylene content in a range from about 5 mole percent to about 95 mole percent.

34. The separation membrane according to any one of Embodiments 1-8, wherein the ethylene vinyl alcohol polymeric material has an ethylene content in a range from about 20 mole percent to about 80 mole percent.

35. The separation membrane according to any one of Embodiments 1-8, wherein the ethylene vinyl alcohol polymeric material has a weight average molecular weight of greater than 500 Daltons and less than 6,000,000 Daltons.

36. The separation membrane according to any one of Embodiments 1-8, wherein the ethylene vinyl alcohol polymeric material is a reaction product prepared from a functional or cross-linking group; and/or wherein each of the one or more selective layers, the first selective layer, and/or the second selective layer independently comprises a poly(vinyl alcohol) polymeric material which is another reaction product prepared from the functional or cross-linking group, wherein the functional or cross-linking group contains an aldehyde, H(O)CR, having at least one of the chemical formulas represented by the following formulas represented by Formulas (1a)-(1i), respectively, respectively, where R is:

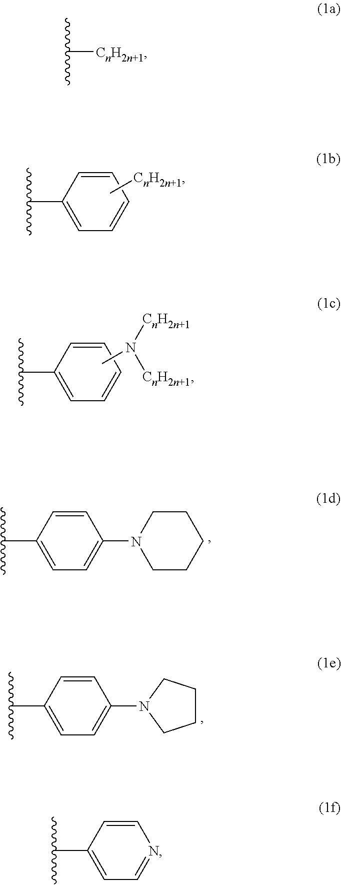

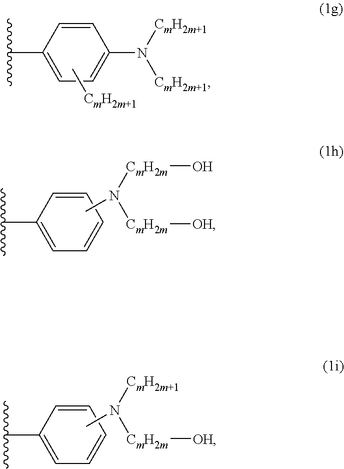

or any combination thereof, and wherein n of Formulas (1a)-(1c) is an integer in a range from 0 to about 18, and m of Formulas (1g)-(1i) is an integer in a range from 1 to about 18.

37. The separation membrane of Embodiment 36, wherein the poly(vinyl alcohol) polymeric material has a weight average molecular weight of greater than 500 Daltons and less than 6,000,000 Daltons.

38. The separation membrane of Embodiment 36, wherein each of the one or more selective layers, the first selective layer, and/or the second selective layer independently comprises a catalyst, and wherein the catalyst comprises an acid or a base.

39. The separation membrane of Embodiment 38, wherein the catalyst comprises an acid, and wherein the acid is selected from the group consisting of hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, and any combination thereof.

40. The separation membrane of Embodiment 38, wherein the catalyst comprises a base, and wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, and any combination thereof.

41. The separation membrane according to any one of Embodiments 1-8, wherein the ethylene vinyl alcohol polymeric material is a reaction product prepared from a functional or cross-linking group, and/or wherein each of the one or more selective layers, the first selective layer, and/or the second selective layer independently comprises a poly(vinyl alcohol) polymeric material which is another reaction product prepared from the functional or cross-linking group, wherein the functional or cross-linking group contains a dialdehyde having at least one of the chemical formulas represented by Formulas (2a)-(2b), respectively:

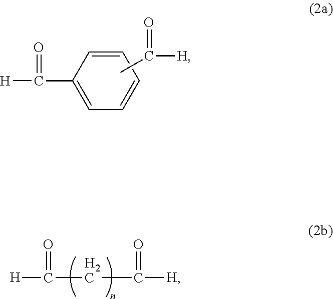

or any combination thereof, wherein n of Formula (2b) is an integer from 1 to about 18.

42. The separation membrane of Embodiment 41, wherein each of the one or more selective layers, the first selective layer, and/or the second selective layer independently further comprises a catalyst, and wherein the catalyst comprises an acid or a base.

43. The separation membrane of Embodiment 42, wherein the catalyst comprises an acid, and wherein the acid is selected from the group consisting of hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, and any combination thereof.

44. The separation membrane of Embodiment 42, wherein the catalyst comprises a base, and wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, and any combination thereof.

45. The separation membrane according to any one of Embodiments 1-8, wherein the ethylene vinyl alcohol polymeric material is a reaction product prepared from a functional or cross-linking group, and/or wherein each of the one or more selective layers, the first selective layer, and/or the second selective layer independently comprises a poly(vinyl alcohol) polymeric material which is another reaction product prepared from the functional or cross-linking group, wherein the functional or cross-linking group contains a diepoxide having the chemical formula represented by Formula (3):

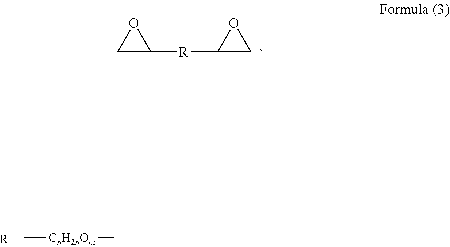

wherein n of Formula (3) is an integer from 0 to about 18, and m of Formula (3) is an integer from 0 to 4.

46. The separation membrane of Embodiment 45, wherein each of the one or more selective layers, the first selective layer, and/or the second selective layer independently comprises a catalyst, and wherein the catalyst comprises an acid or a base.

47. The separation membrane of Embodiment 46, wherein the catalyst comprises an acid, and wherein the acid is selected from the group consisting of hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, and any combination thereof.

48. The separation membrane of Embodiment 46, wherein the catalyst comprises a base, and wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, and any combination thereof.

49. The separation membrane according to any one of Embodiments 1-8, wherein each of the one or more selective layers, the first selective layer, and/or the second selective layer independently comprises an amine-containing polymeric material selected from the group consisting of polymethyleneamine, polyvinylamine, polyallylamine, linear polyethylenimine, branched polyethylenimine, an oligomer thereof, a complex thereof, a derivative thereof, and any combination thereof.

50. The separation membrane of Embodiment 49, wherein the amine-containing polymeric material is a reaction product prepared from a functional or cross-linking group, wherein the functional or cross-linking group contains an aldehyde, H(O)CR, having at least one of the chemical formulas represented by the following Formulas (4a)-(4i), respectively, where R is:

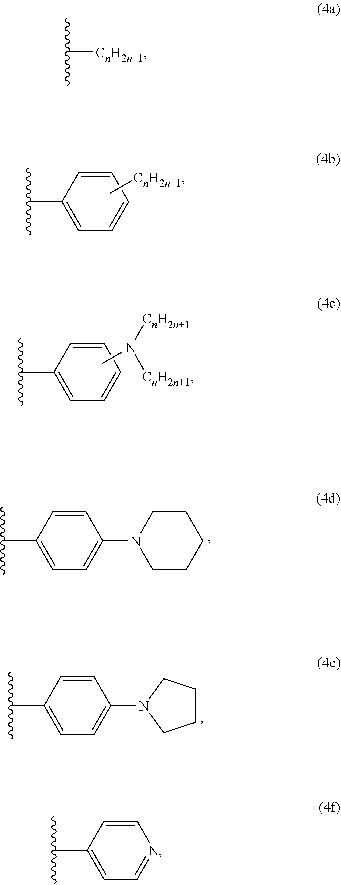

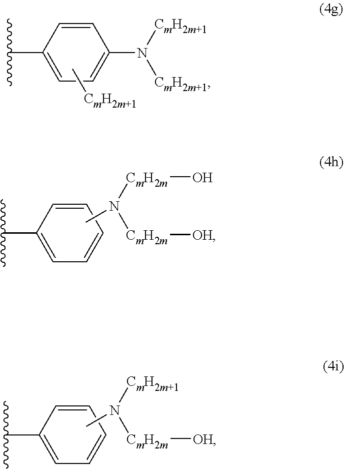

or any combination thereof, and wherein n of Formulas (4a)-(4c) is an integer in a range from 0 to about 18, and each m of Formulas (4g)-(4i) is independently an integer in a range from 1 to about 18.

51. The separation membrane of Embodiment 50, wherein the amine-containing polymeric material further comprises a catalyst, and wherein the catalyst comprises an acid or a base.

52. The separation membrane of Embodiment 51, wherein the catalyst comprises an acid, and wherein the acid is selected from the group consisting of hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, and any combination thereof.

53. The separation membrane of Embodiment 51, wherein the catalyst comprises a base, and wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, and any combination thereof.

54. The separation membrane of Embodiment 49, wherein the amine-containing polymeric material is a reaction product prepared from a functional or cross-linking group, wherein the functional or cross-linking group contains a dialdehyde having at least one of the chemical formulas represented by the following Formulas (5a)-(5b), respectively:

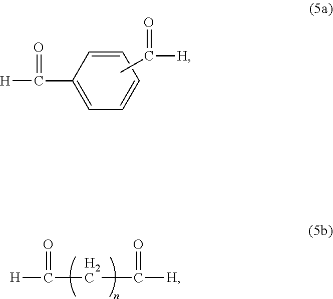

or any combination thereof, wherein n of Formula (5b) is an integer from 1 to about 18.

55. The separation membrane of Embodiment 54, wherein the amine-containing polymeric material further comprises a catalyst, and wherein the catalyst comprises an acid or a base.

56. The separation membrane of Embodiment 55, wherein the catalyst comprises an acid, and wherein the acid is selected from the group consisting of hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, and any combination thereof.

57. The separation membrane of Embodiment 55, wherein the catalyst comprises a base, and wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, and any combination thereof.

58. The separation membrane of Embodiment 49, wherein the amine-containing polymeric material is a reaction product prepared from a functional or cross-linking group, wherein the functional or cross-linking group contains a diepoxide having the chemical formula represented by the following Formula (6):

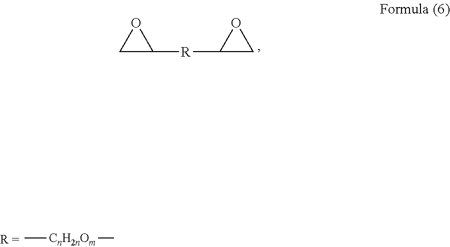

wherein n of Formula (6) is an integer from 0 to about 18, and m of Formula (6) is an integer from 0 to 4.

59. The separation membrane of Embodiment 58, wherein the amine-containing polymeric material further comprises a catalyst, and/or wherein each of the one or more selective layers, the first selective layer, and/or the second selective layer independently comprises the poly(vinyl alcohol) polymeric material and the catalyst, and wherein the catalyst comprises an acid or a base.

60. The separation membrane of Embodiment 59, wherein the catalyst comprises an acid, and wherein the acid is selected from the group consisting of hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, and any combination thereof.

61. The separation membrane of Embodiment 59, wherein the catalyst comprises a base, and wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, and any combination thereof.

62. The separation membrane according to any one of Embodiments 1-8, wherein each of the one or more selective layers, the first selective layer, and/or the second selective layer independently comprises an amine-containing polymeric material comprising a reaction product between an epoxide and at least one material selected from the group consisting of polymethyleneamine, polyvinylamine, polyallylamine, linear polyethylenimine, branched polyethylenimine, an oligomer thereof, a complex thereof, a derivative thereof, and any combination thereof.

63. The separation membrane of Embodiment 62, wherein the reaction product is produced by combining a molar ratio of the epoxide to amine groups of polymethyleneamine, polyvinylamine, polyallylamine, linear polyethylenimine, branched polyethylenimine, or combinations thereof, wherein the molar ratio is in a range from about 1:100 to about 20:1.

64. The separation membrane of Embodiment 62, wherein the reaction product is produced by combining a molar ratio of the epoxide to amine groups of polymethyleneamine, polyvinylamine, polyallylamine, linear polyethylenimine, branched polyethylenimine, or combinations thereof, wherein the molar ratio is in a range from about 1:10 to about 6:1.

65. The separation membrane of Embodiment 62, wherein the reaction product has at least one of the chemical formulas represented by the following Formulas (7a)-(7b), respectively:

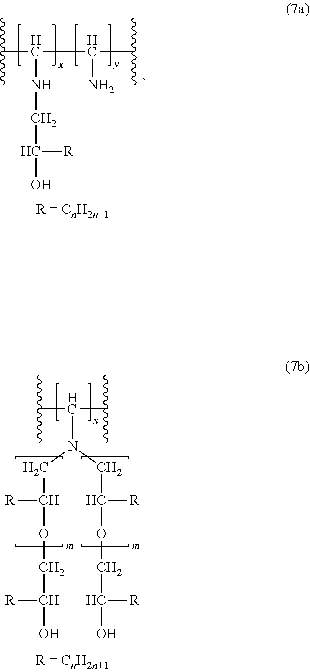

or any combination thereof, and wherein x of Formulas (7a)-(7b) is an integer in a range from about 10 to about 1,000,000, y of Formula (7a) is an integer in a range from about 10 to about 1,000,000, n of Formulas (7a)-(7b) is an integer in a range from 0 to about 18, and each m of Formula (7b) is independently an integer in a range from 0 to about 10.

66. The separation membrane of Embodiment 62, wherein the reaction product has at least one of the chemical formulas represented by the following Formulas (8a)-(8b), respectively:

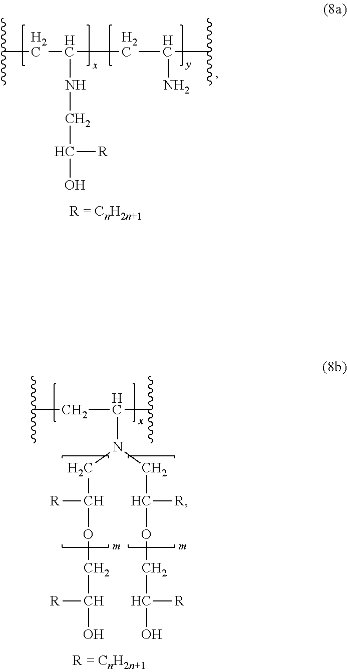

or any combination thereof, and wherein x of Formulas (8a)-(8b) is an integer in a range from about 10 to about 1,000,000, y of Formula (8a) is an integer in a range from about 10 to about 1,000,000, n is an integer in of Formulas (8a)-(8b) a range from 0 to about 18, and each m of Formula (8b) is independently an integer in a range from 0 to about 10.

67. The separation membrane of Embodiment 62, wherein the reaction product has at least one of the chemical formulas represented by the following Formulas (9a)-(9b), respectively:

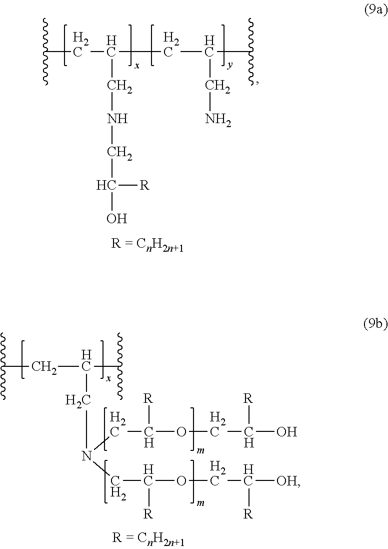

or any combination thereof, and wherein x of Formulas (9a)-(9b) is an integer in a range from about 10 to about 1,000,000, y of Formula (9a) is an integer in a range from about 10 to about 1,000,000, n of Formulas (9a)-(9b) is an integer in a range from 0 to about 18, and each m of Formula (9b) is independently an integer in a range from 0 to about 10.

68. The separation membrane of Embodiment 62, wherein the reaction product has at least one of the chemical formulas represented by the following Formulas (10a)-(10b), respectively:

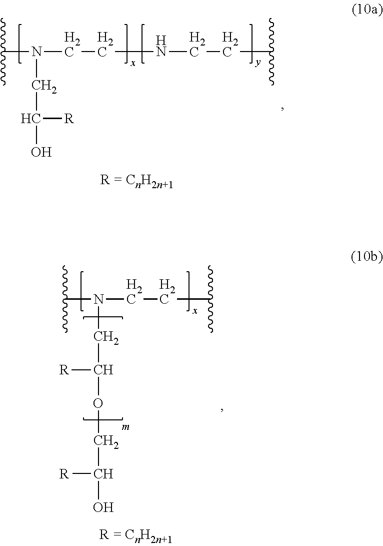

or any combination thereof, wherein x of Formulas (10a)-(10b) is an integer in a range from about 10 to about 1,000,000, y of Formula (10a) is an integer in a range from about 10 to about 1,000,000, n of Formulas (10a)-(10b) is an integer in a range from 0 to about 18, and m of Formula (10b) is an integer in a range from 0 to about 10.

69. The separation membrane of Embodiment 62, wherein the reaction product has at least one of the chemical formulas represented by the following Formulas (11a)-(11b), respectively:

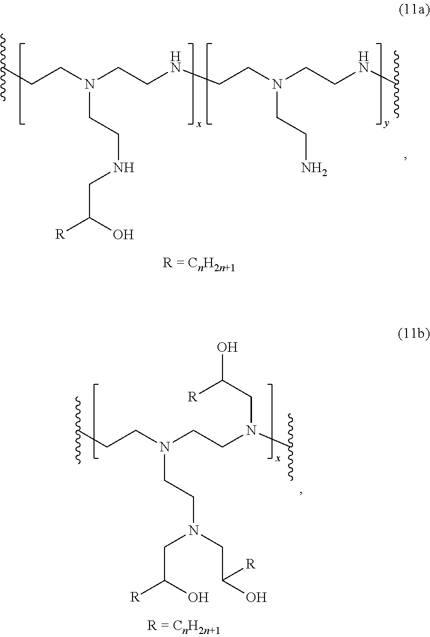

or any combination thereof, wherein x of Formulas (11a)-(11b) is an integer in a range from about 10 to about 1,000,000, y of Formula (11a) is an integer in a range from about 10 to about 1,000,000, and n of Formulas (11a)-(11b) is an integer in a range from 0 to about 18.

70. The separation membrane according to any one of Embodiments 62-69, wherein the epoxide comprises ethylene oxide, propylene oxide, or a combination thereof.

71. The separation membrane according to any one of Embodiments 62-69, wherein the reaction product is produced with a catalyst, and wherein the catalyst comprises an acid or a base.

72. The separation membrane of Embodiment 71, wherein the catalyst comprises an acid, and wherein the acid is selected from the group consisting of hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, and any combination thereof.

73. The separation membrane of Embodiment 71, wherein the catalyst comprises a base, and wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, and any combination thereof.

74. The separation membrane of Embodiment 71, wherein the catalyst and the epoxide are added together at a catalyst to epoxide weight ratio in a range from about 1:100,000 to about 1 to 1.

75. The separation membrane of Embodiment 71, wherein the catalyst and the epoxide are added together at a catalyst to epoxide weight ratio in a range from about 1:9,999 to about 1 to 1.

76. The separation membrane according to any one of Embodiments 1-8, wherein the separation membrane comprises a plurality of selective layers disposed on or over the gutter layer or the porous support layer, and wherein the plurality of selective layers comprises from 3 selective layers to about 200 selective layers.

77. The separation membrane of Embodiment 76, wherein each of the selective layers comprises a different composition than the composition of an adjacent or neighboring selective layer.

78. A method for separating a targeted gas, comprising: introducing a gas mixture comprising the targeted gas and a base gas to a feed side of the separation membrane according to any one of Embodiments 1-4, wherein the separation membrane contains the feed side opposite of a permeate side; removing the targeted gas from the feed side of the separation membrane while retaining the base gas on the feed side; and recovering the targeted gas from the permeate side.

79. The method of Embodiment 78, wherein the targeted gas comprises a gas is selected from the group consisting of helium, hydrogen (H₂), oxygen (O₂), and any combination thereof.

80. The method of Embodiment 79, wherein the base gas comprises a gas is selected from the group consisting of methane, ethane, ethene, propylene, other hydrocarbon gases, nitrogen (N₂), carbon dioxide, carbon monoxide, hydrogen sulfide, ammonia, water, and any combination thereof.

81. The method of Embodiment 79, wherein the gas mixture comprises a gas is selected from the group consisting of air, natural gas, flue gas, syngas, biogas, a refinery gas, and any combination thereof.

82. A method for separating a targeted gas, comprising: introducing a gas mixture comprising the targeted gas and a base gas to a feed side of the separation membrane according to any one of Embodiments 5-8, wherein the separation membrane contains the feed side opposite of a permeate side; removing the targeted gas from the feed side of the separation membrane while retaining the base gas on the feed side; and recovering the targeted gas from the permeate side.

83. The method of Embodiment 82, wherein the targeted gas comprises a gas is selected from the group consisting of carbon dioxide, hydrogen sulfide, hydrogen chloride, hydrogen fluoride, nitrogen oxide, sulfur oxide, and any combination thereof.

84. The method of Embodiment 83, wherein the base gas comprises a gas is selected from the group consisting of methane, a hydrocarbon gas, nitrogen (N₂), oxygen (O₂), hydrogen (H₂), argon, helium, carbon monoxide, and any combination thereof.

85. The method of Embodiment 83, wherein the gas mixture comprises a gas is selected from the group consisting of air, natural gas, flue gas, syngas, biogas, one or more gases from a refinery, a power plant, a cement plant, a steel plant, and any combination thereof.

86. A method for separating a targeted gas, comprising: introducing air comprising carbon dioxide and a base gas to a feed side of the separation membrane according to any one of Embodiments 1-8, wherein the separation membrane contains the feed side opposite of a permeate side; removing the carbon dioxide from the feed side of the separation membrane while retaining the base gas on the feed side; recovering the carbon dioxide from the permeate side; and introducing the recovered carbon dioxide into a greenhouse containing plants.

87. The method of Embodiment 86, wherein the carbon dioxide is mixed with additional air at a volume ratio of the carbon dioxide to the additional air in a range from about 1 to 100 to about 100 to 1 to produce a gas mixture.

88. The method of Embodiment 87, wherein the additional air is contained outside of the greenhouse, inside the greenhouse, or a combination thereof.

89. The method of Embodiment 87 or 88, wherein the gas mixture is introduced into the greenhouse, produced inside of the greenhouse, or a combination thereof.

90. The method according to any one or claim 87-89, wherein the gas mixture introduced to the greenhouse has a carbon dioxide concentration in a range from about 500 parts per million (ppm) to about 10,000 ppm.

91. A method for separating a targeted gas, comprising: introducing a gas mixture comprising the targeted gas and a base gas to a feed side of the separation membrane according to any one of Embodiments 1-77, wherein the separation membrane contains the feed side opposite of a permeate side; removing the targeted gas from the feed side of the separation membrane while retaining the base gas on the feed side; and recovering the targeted gas from the permeate side.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated. As used herein, the term “about” refers to a +/−10% variation from the nominal value. It is to be understood that such a variation can be included in any value provided herein.

Certain embodiments and features have been described using a set of numerical upper limits and a set of numerical lower limits. It should be appreciated that any stated range of numerical values includes the lower endpoint value and the upper endpoint value, unless otherwise indicated. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

1-91. (canceled)

92. A separation membrane, comprising:
a non-woven fabric backing;
a porous support layer disposed on the non-woven fabric backing; and
one or more selective layers disposed on or above the porous support layer, wherein each of the selective layers independently comprises a selective polymeric material, wherein at least one of the selective layers comprises an ethylene vinyl alcohol polymeric material as the selective polymeric material.

93. The separation membrane of claim 92, wherein the separation membrane has a thickness in a range from about 60 μm to about 2 mm.

94. The separation membrane of claim 92, wherein each of the one or more selective layers is independently configured to separate helium, hydrogen (H₂), oxygen (O₂), or any combination thereof from a gas mixture comprising a base gas and at least one gas selected from the group consisting of helium, hydrogen (H₂), oxygen (O₂), and any combination thereof.

95. The separation membrane of claim 94, wherein the base gas comprises a substance selected from the group consisting of methane, ethane, ethene, propylene, other hydrocarbon gases, nitrogen (N₂), carbon dioxide, carbon monoxide, hydrogen sulfide, ammonia, water, and any combination thereof.

96. The separation membrane of claim 94, wherein the base gas comprises a gas selected from the group consisting of air, natural gas, flue gas, syngas, biogas, refinery off-gases, and any combination thereof.

97. The separation membrane of claim 92, wherein the separation membrane is configured as a flat sheet membrane, a spiral-wound membrane, a hollow fiber membrane, or a plate-and-frame membrane.

98. The separation membrane of claim 92, wherein each of the one or more selective layers is independently configured to separate a gas from a gas mixture comprising a base gas and the gas, and wherein the gas is selected from the group consisting of carbon dioxide, hydrogen sulfide, hydrogen chloride, hydrogen fluoride, nitrogen oxide, sulfur oxide, and any combination thereof.

99. The separation membrane of claim 92, wherein each of the one or more selective layers independently has a thickness in a range from about 1 nm to about 100 μm, and wherein each of the one or more selective layers is independently a non-porous layer.

100. The separation membrane of claim 92, wherein the ethylene vinyl alcohol polymeric material has an ethylene content in a range from about 5 mole percent to about 95 mole percent.

101. The separation membrane of claim 92, wherein the ethylene vinyl alcohol polymeric material has a weight average molecular weight of greater than 500 Daltons and less than 6,000,000 Daltons.

102. The separation membrane of claim 92, wherein the ethylene vinyl alcohol polymeric material is a reaction product prepared from a functional or cross-linking group, wherein each of the one or more selective layers independently comprises a poly(vinyl alcohol) polymeric material which is another reaction product prepared from the functional or cross-linking group, wherein the functional or cross-linking group contains an aldehyde, H(O)CR, having at least one of the chemical formulas represented by the following formulas represented by Formulas (1a)-(1i), respectively, where R is: 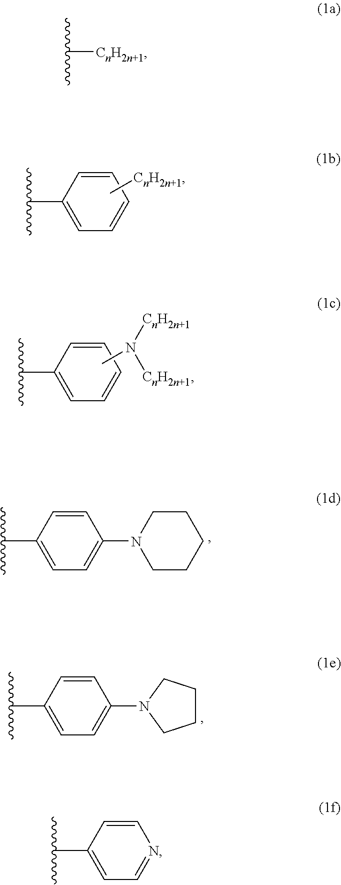 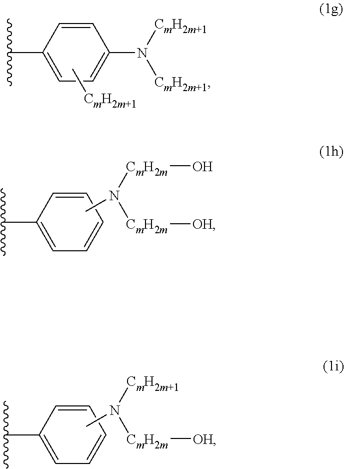
or any combination thereof, and wherein n of Formulas (1a)-(1c) is an integer in a range from 1 to about 18, and m of Formulas (1g)-(1i) is an integer in a range from 1 to about 18.

103. The separation membrane of claim 102, wherein the poly(vinyl alcohol) polymeric material has a weight average molecular weight of greater than 500 Daltons and less than 6,000,000 Daltons.

104. The separation membrane of claim 92, wherein the ethylene vinyl alcohol polymeric material is a reaction product prepared from a functional or cross-linking group, wherein each of the one or more selective layers independently comprises a poly(vinyl alcohol) polymeric material which is another reaction product prepared from the functional or cross-linking group, wherein the functional or cross-linking group contains a dialdehyde having at least one of the chemical formulas represented by Formulas (2a)-(2b), respectively: 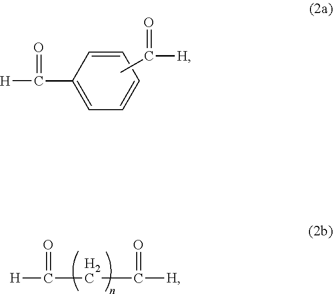
or any combination thereof, and wherein n of Formula (2b) is an integer from 1 to about 18.

105. The separation membrane of claim 92, wherein each of the one or more selective layers independently comprises an amine-containing polymeric material selected from the group consisting of polymethyleneamine, polyvinylamine, polyallylamine, linear polyethylenimine, branched polyethylenimine, an oligomer thereof, a complex thereof, a derivative thereof, and any combination thereof.

106. The separation membrane of claim 92, wherein each of the one or more selective layers independently comprises an amine-containing polymeric material comprising a reaction product between an epoxide and at least one material selected from the group consisting of polymethyleneamine, polyvinylamine, polyallylamine, linear polyethylenimine, branched polyethylenimine, an oligomer thereof, a complex thereof, a derivative thereof, and any combination thereof.

107. The separation membrane of claim 106, wherein the reaction product is produced by combining a molar ratio of the epoxide to amine groups of polymethyleneamine, polyvinylamine, polyallylamine, linear polyethylenimine, branched polyethylenimine, or combinations thereof, wherein the molar ratio is in a range from about 1:100 to about 20:1.

108. The separation membrane of claim 106, wherein the reaction product has at least one of the chemical formulas represented by the following Formulas (7a)-(7b), respectively: 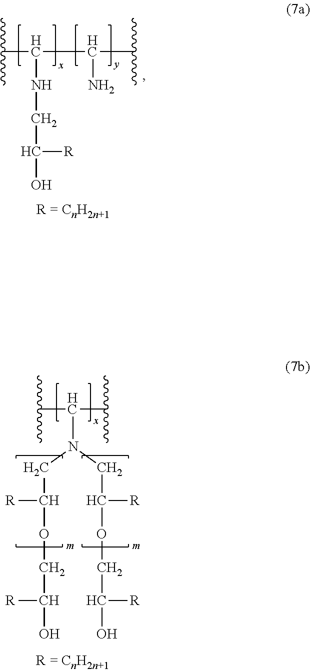
or any combination thereof, and wherein x of Formulas (7a)-(7b) is an integer in a range from about 10 to about 1,000,000, y of Formula (7a) is an integer in a range from about 10 to about 1,000,000, n of Formulas (7a)-(7b) is an integer in a range from 0 to about 18, and each m of Formula (7b) is independently an integer in a range from 0 to about 10.

109. The separation membrane of claim 106, wherein the reaction product has at least one of the chemical formulas represented by the following Formulas (9a)-(9b), respectively: 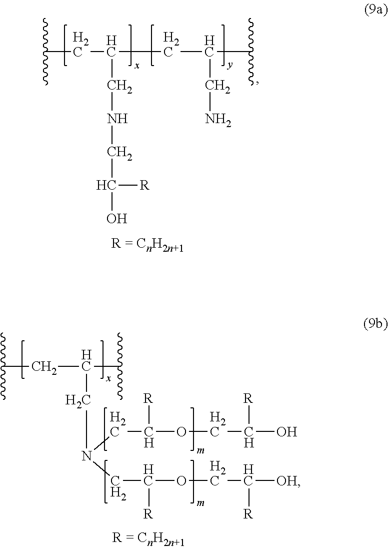
or any combination thereof, and wherein x of Formulas (9a)-(9b) is an integer in a range from about 10 to about 1,000,000, y of Formula (9a) is an integer in a range from about 10 to about 1,000,000, n of Formulas (9a)-(9b) is an integer in a range from 0 to about 18, and each m of Formula (9b) is independently an integer in a range from 0 to about 10.

110. The separation membrane of claim 106, wherein the epoxide comprises ethylene oxide, propylene oxide, or a combination thereof.

111. A method for separating a targeted gas, comprising:
introducing air comprising the targeted gas and a base gas to a feed side of the separation membrane, wherein the separation membrane contains the feed side opposite of a permeate side, and wherein the separation membrane comprises:
a non-woven fabric backing;
a porous support layer disposed on the non-woven fabric backing; and
one or more selective layers disposed on or above the porous support layer, wherein each of the selective layers independently comprises a selective polymeric material, wherein at least one of the selective layers comprises an ethylene vinyl alcohol polymeric material as the selective polymeric material;
removing the targeted gas from the feed side of the separation membrane while retaining the base gas on the feed side; and
recovering the targeted gas from the permeate side.
